(19) United States
(12) Patent Application Publication
(10) Pub. No.: US 2021/0124919 A1
(43) Pub. Date: Apr. 29, 2021

(54) System and Methods for Authentication of Documents

(71) Applicant: Woolly Labs, Inc., DBA Vouched, Seattle, WA (US)

(72) Inventors: Vasanth Balakrishnan, Singapore (SG); John Cao, Seattle, WA (US); John Baird, Seattle, WA (US); Yakov Keselman, Bellevue, WA (US)

(21) Appl. No.: 17/081,411

(22) Filed: Oct. 27, 2020

Related U.S. Application Data
(60) Provisional application No. 62/927,322, filed on Oct. 29, 2019.
(60) Provisional application No. 63/078,507, filed on Sep. 15, 2020.

(51) Int. Cl. G06K 9/00; G06K 9/68; G06K 9/62; G06F 21/64; G06F 16/93

(52) U.S. Cl. CPC G06K 9/00483; G06K 9/00469; G06K 9/6828; G06K 2209/01; G06F 21/64; G06F 16/93; G06K 2209/25; G06K 9/6203

(57) ABSTRACT

A system and methods directed to the authentication/verification of identification and other documents. Such documents may include identity cards, driver's licenses, passports, documents being used to show a proof of registration or certification, voter ballots, data entry forms, etc. The authentication or verification process may be performed for purposes of control of access to information, control of access to and/or use of a venue, a method of transport, or a service, for assistance in performing a security function, to establish eligibility for and enable provision of a government provided service or benefit, etc. The authentication or verification process may also or instead be performed for purposes of verifying a document itself as authentic so that the information it contains can confidently be assumed to be accurate and reliable.

### CROSS REFERENCE TO RELATED APPLICATIONS

This application claims the benefit of U.S. Provisional Application No. 62/927,322, entitled “System and Methods for Authentication of Identification Documents,” filed Oct. 29, 2019, the disclosure of which is incorporated, in its entirety (including the Appendix), by this reference.

This application also claims the benefit of U.S. Provisional Application No. 63/078,507, entitled “System and Methods for Authentication of Documents,” filed Sep. 15, 2020, the disclosure of which is incorporated, in its entirety (including the Appendix), by this reference.

### BACKGROUND

Documents are used for many purposes, including for identifying a person so that they may access services, venues, transport, information, or other benefits or privileges. Documents may also be used to allow a person to register for a service, to vote, to submit personal information, to verify completion of a course of study, etc. For many of these uses, it is important that only properly identified persons based on properly authenticated/verified documents are provided access. For other uses it is important that the document itself be verified as authentic so that the information it contains can confidently be assumed to be accurate and reliable. As a result, the accuracy and scalability of authentication processes used to verify documents are of great importance.

Although there are conventional approaches to performing authentication or verification of identify and other types of documents, such approaches have one or more significant disadvantages. These include the introduction of human error into the classification or authentication process and/or limitations in identifying the source or reasons for a classification decision introduced by an automated or semi-automated process.

Conventional approaches to document authentication or verification suffer from one or more disadvantages. Thus, systems and methods are needed for more efficiently and accurately performing these functions. Embodiments of the invention are directed toward solving these and other problems individually and collectively.

### SUMMARY

The terms “invention,” “the invention,” “this invention,” “the present invention,” “the present disclosure,” or “the disclosure” as used herein are intended to refer broadly to all of the subject matter described in this document, the drawings or figures, and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification of this patent, to any or all figures or drawings, and to each claim.

Embodiments of the system and methods described herein are directed to the authentication/verification of identification and other documents. Such documents may include identity cards, driver's licenses, passports, documents being used to show a proof of registration or certification, voter ballots, data entry forms, etc. The authentication or verification process may be performed for purposes of control of access to information, control of access to and/or use of a venue, a method of transport, or a service, for assistance in performing a security function, to establish eligibility for and enable provision of a government provided service or benefit, etc. The authentication or verification process may also or instead be performed for purposes of verifying a document itself as authentic so that the information it contains can confidently be assumed to be accurate and reliable. As another example, the image and text processing described herein could be used with robotic-process-automation efforts, which rely on an understanding of a current computer screen and operate to infer a user's activities.

In some embodiments, the systems and methods described herein use one or both of a set of image processing and text processing functions or capabilities to verify the authenticity of a subject document. The image processing functions include determining a template or representative document category or type, determining a transformation (if needed) to better “align” the image of a subject document with a standard undistorted image in the template, extracting specific data or elements of the subject document, and comparing the extracted data or elements to known valid data or elements. The text processing functions include extracting an alphanumeric text character or characters from an image of a subject document, determining one or more characteristics of the character or characters (such as font type, size, spacing/kerning, whether bolded, italicized, underlined, etc.), and comparing the determined characteristics to known valid characteristics contained in a template of the document type believed to be associated with the subject document.

In some embodiments, the disclosure is directed to a system for authenticating a document, where the system includes an electronic processor programmed with a set of executable instructions, where when executed, the instructions cause the system to:
receive an image of a subject document;
identify one or more invariable attributes of the subject document, wherein an invariable attribute is one or more of a label, a title, a header, a field name, a logo, a hologram, a watermark, or a seal;
access a set of document templates, wherein each template represents an example of a type of document and includes information regarding a set of invariable attributes associated with each type of document;
identify a template in the set of document templates representing a document of the type of the subject document by comparing the identified invariable attributes of the subject document with the invariable attributes associated with each type of document of the set of templates;
access data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verify that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identify one or more elements of data placed in a field of the subject document for additional processing, wherein the additional processing includes comparing the identified data to the accessed data associated with the identified template, and further, wherein the additional processing comprises one or more of:
   fraud detection processing to identify possible instances of alteration or tampering with a document;
   format checking to determine if invariable attributes and the identified data are in an expected format for the type of document represented by the identified template;
   font verification processing to determine if the identified data is in the expected font type and font characteristic for the type of document represented by the identified template; and
   if applicable, accessing an external database to confirm validity of one or more of the identified data; and
if the additional processing indicates that the subject document is valid, then generating an indication that the subject document and the information it contains are valid.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1(a) is a diagram illustrating an example document that might be a subject of the authentication/verification processing described herein, with indications of certain example features or aspects of the document, in accordance with some embodiments;

FIG. 1(b) is a flowchart or flow diagram illustrating an example process, operation, method, or function for authenticating/verifying a document, in accordance with some embodiments of the system and methods described herein;

FIG. 1(c) is a second flowchart or flow diagram illustrating an example process, operation, method, or function for authenticating/verifying a document, in accordance with some embodiments of the system and methods described herein;

FIGS. 1(d)-1(f) are diagrams illustrating three example transformations (homography, affine and rotation, respectively) that may be applied to an image of a document as part of an authentication/verification process, method, function or operation, in accordance with some embodiments;

FIG. 1(g) is a block diagram illustrating the primary functional elements or components of an example workflow or system for authenticating/verifying a document, in accordance with some embodiments;

FIG. 2(a) is a flowchart or flow diagram illustrating an example process, operation, method, or function for estimating a transformation that may be applied to an image of a subject document, in accordance with some embodiments of the system and methods described herein;

FIG. 2(b) is a flowchart or flow diagram illustrating an example process, operation, method, or function for generating a confidence score for a subject document with respect to a possible template based on a sampling of points in a transformed image, in accordance with some embodiments of the system and methods described herein;

FIG. 2(c) is a diagram illustrating an example of a “heat” map representing a confidence level in the accuracy of extracted document attributes, and which provides a visual indication of the verification accuracy of regions of a document subjected to processing by an embodiment of the system and methods described herein;

FIG. 3 illustrates two identification documents from the same state and shows how the documents may use different fonts, and how a single document may use different fonts for different attributes;

FIG. 4 is a diagram illustrating elements or components that may be present in a computer device or system configured to implement a method, process, function, or operation in accordance with an embodiment of the invention; and

FIGS. 5-7 are diagrams illustrating an architecture for a multi-tenant or SaaS platform that may be used in implementing an embodiment of the systems and methods described herein.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the invention will be described more fully herein with reference to the accompanying drawings, which form a part hereof, and which show, by way of illustration, exemplary embodiments by which the invention may be practiced. The invention may, however, be embodied in different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) a suitable non-transitory data storage element. In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or any other suitable form. The following detailed description is, therefore, not to be taken in a limiting sense.

Embodiments of the system and methods described herein are directed to the authentication/verification of identification and other documents. Such documents may include (but are not limited to) identity cards, driver's licenses, passports, educational certificates, diplomas, bank statements, proof of address statements, birth certificates, billing statements, insurance cards, digital identity and electronic national identity documents, documents being used to show a proof of registration or certification of having completed a course or licensing program for a profession, or a voter registration form or ballot. The document authentication process described herein is country and language agnostic and can be applied to documents having a variety of different attributes, including, but not limited to or required to include, images, digital hashes, text, and holograms. The authentication or verification processing described is typically (although not exclusively) performed for purposes of control of access to information, control of access to and/or use of a venue, a method of transport, or a service, for assistance in performing a security function, to establish eligibility for and enable provision of a government provided service or benefit, or to determine the reliability of information contained in a document.

Many conventional approaches to document verification involve some degree of manual verification of document elements (typically, to a limited number of such elements). These elements may include logos, fields such as names, DOB, address, holograms, signatures, etc. The manual (human) verifier may also check for specific instances of fraud attempts or scenarios by attempting to determine if the document has been altered in any way, shape or form.

However, such manual approaches to document authentication suffer from one or more significant disadvantages, including the following:
Humans are prone to missing details—some types of document alterations might not be identifiable at a glance;
Repeated processing of the same type of information causes mental fatigue, which can severely affect an individual's ability to correctly identify and verify documents;
Humans can become confused by the changing rules involved in verifying document authenticity, as well as the levels of verification necessary for different use cases;
This type of manual review process is difficult to scale as the number of documents increases or when there is a relatively high throughput requirement; and
Manual processing lacks consistency, as individuals may disagree on whether a document is valid or invalid.

Other approaches to document verification may include some degree of automation or semi-automation and typically involve using a classifier to identify and attempt to authenticate a document type or class. In some cases, these approaches may use detection models to detect the document from an input image.

However, as with the manual approaches to document authentication, the automated or semi-automated also suffer from one or more significant disadvantages, including the following:
Detectors typically produce a cropped version of a card or document depending on the edge boundaries, where the detected edges may vary depending on occlusion, tampering, folding etc. In most cases, there is no refinement done on top of the detection output and this causes a propagation of the errors in detection to the later verification stage(s);
While classifiers are relatively good at telling which class/type a card or document belongs to, they are not vas effective at detecting certain of the nuances that may be important to actual verification of a document. As a result, such classifiers are typically used only at the document level and not at a field level (i.e., they are not used to detect and/or verify specific information contained in a document);
Since classifiers are used at the document level, there is no aggregation on a per field basis. When a particular document is classified as valid or fake, there is no way to tell which field or fields contributed to the decision and to what extent each contributed to the final decision or classification. This can be a problem, as it prevents being able to narrow down the cause of a classification and examine it more closely if needed, as well as to understand how much a particular field contributed to a final classification;
   for example, if a particular field value was a primary factor in classifying a document as authentic or as not authentic, and it is later determined that the field value was misunderstood or of lower relevance, then it may not be possible to determine which document classifications should be re-evaluated;
Document level classification doesn't allow for convenient implementation of changes to the rules used for verification, which may depend on the use case. Often, the process of modifying verification rules involves training a new model that has been adjusted for the new set of rules—this can take time, the provision of a large number of data sets and human input as part of a supervised learning process;
Classifiers trained on a particular set of documents are biased towards the features and structure or arrangement of that set of training documents. They are also more difficult to scale with newer or more varied sets of documents, particularly without the availability of a significant amount of training data; and
Some approaches rely on scanning barcodes (such as MRZ or PDF417) for textual extraction. But MRZ or PDF417 codes can be readily generated given the content and hence are relatively easy to spoof, and by nature, impossible to detect as fraudulent.

A robust and effective system (i.e., one that is accurate, reliable, and scalable, among other characteristics) for the authentication and/or verification of documents and the subsequent verification of the identity of a person or the contents of a document will typically involve several primary functions or operations. In some embodiments, these include:
Information identification/extraction;
   From a given sample (such as an image of a document), acquire a set of the graphical and textual elements that are present in the document. These elements may include a document type, version, a name, an address, a signature, a face, a stamp, a seal, a date of birth, or other data that might be part of the document and can be evaluated as an indicia of the document's validity;
Digitization and filtering or processing (if needed) of the extracted information and data; and
Document verification/authentication
   Given a sample (an image, scan or original) of a document, verify the authenticity of the document represented in the sample—confirm that it is of a corresponding source document and has not been altered.

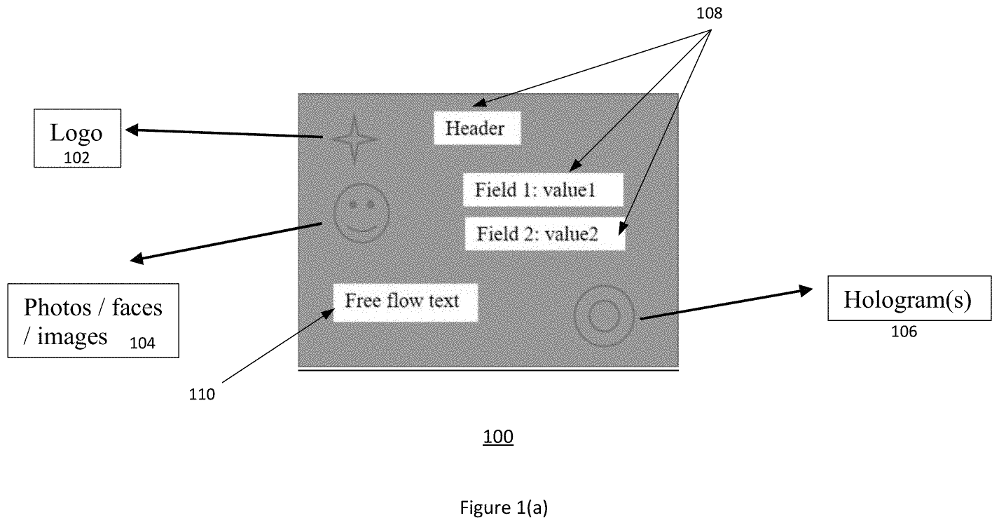

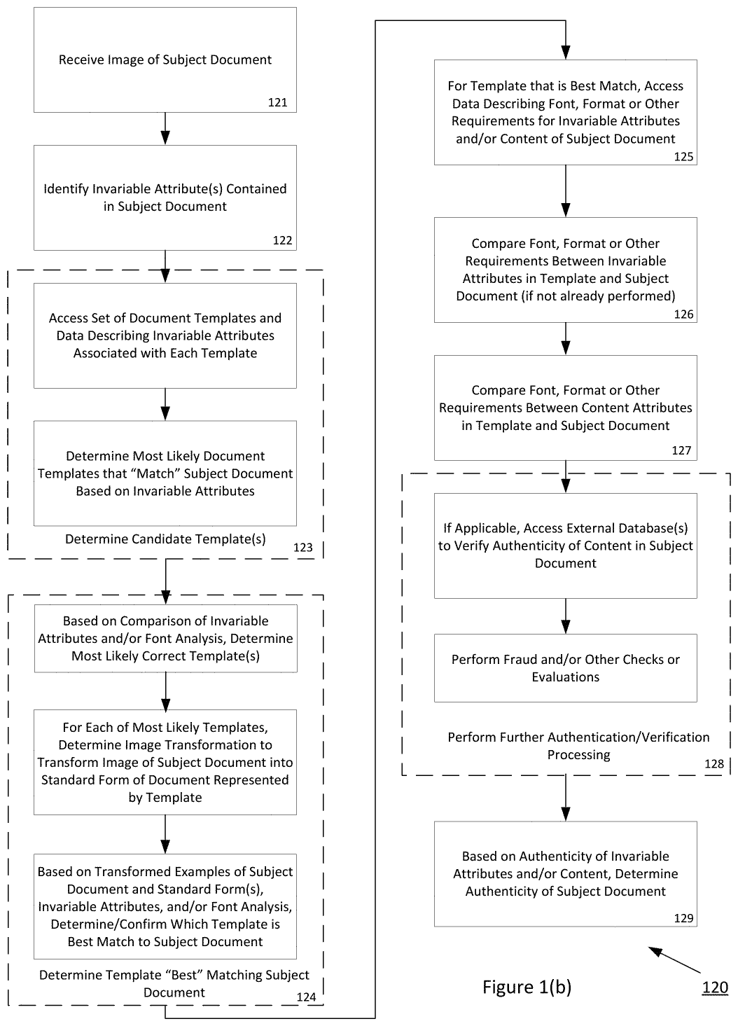

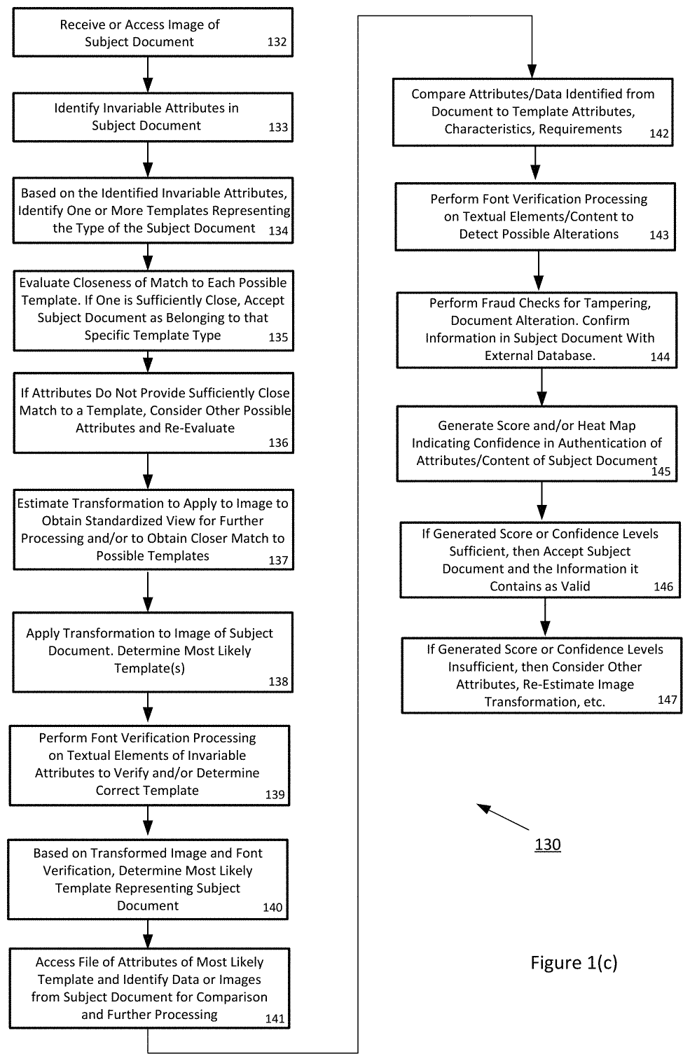

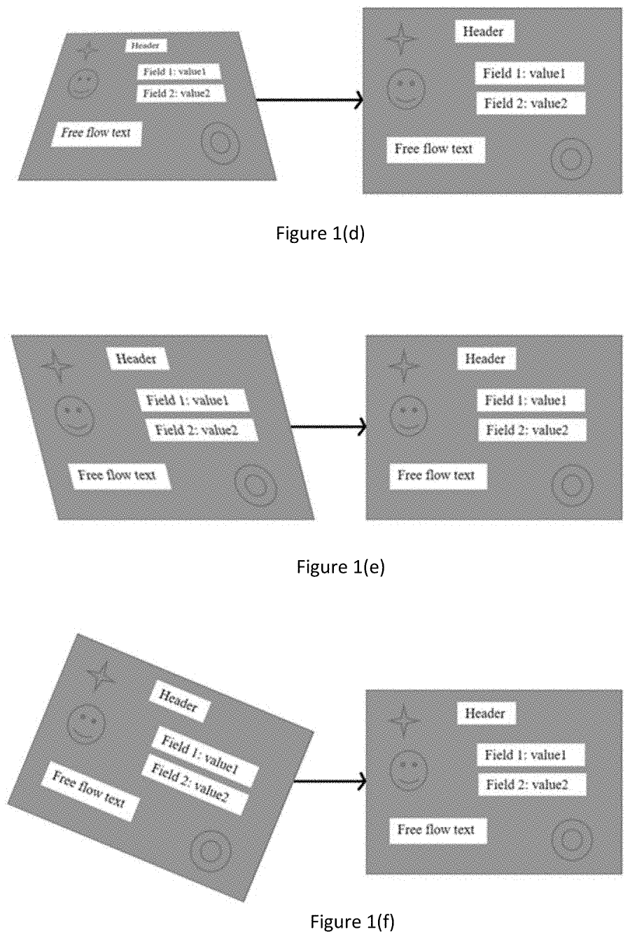

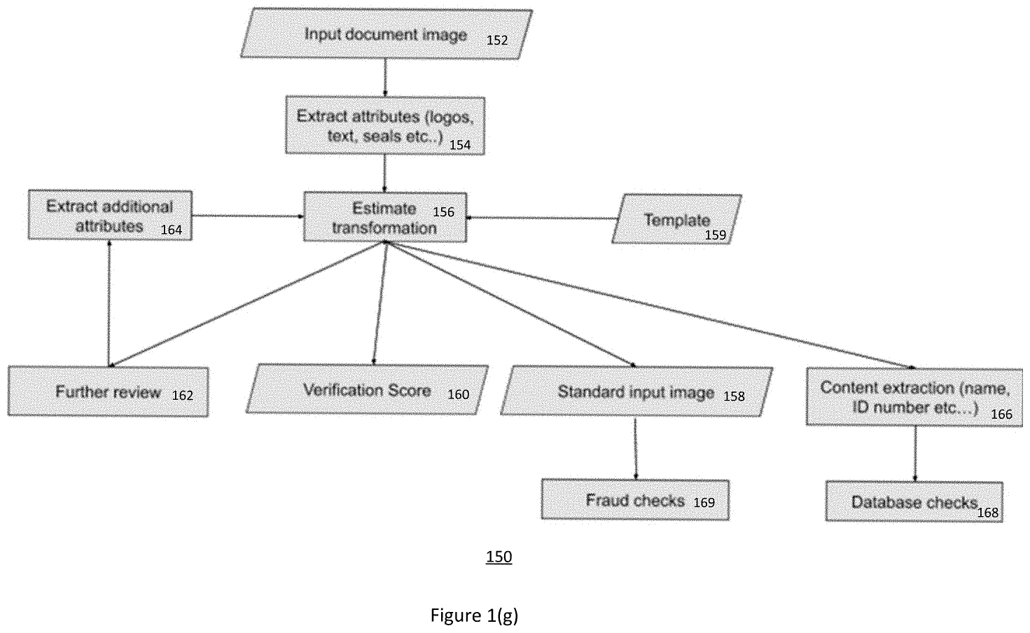

FIG. 1(a) is a diagram illustrating an example document 100 that might be a subject of the authentication/verification processing described herein, with indications of certain example features or aspects of the document, in accordance with some embodiments. The document being examined (referred to as the subject document herein) for authenticity is provided as an image. The image may be obtained by one or more of a photograph, a scan, OCR, or other suitable process. As shown in the figure, the document may include elements or features such as a logo 102, a photo or similar image 104, a hologram of other specific form of “watermark” or marker 106, one or more data fields 108 containing alphanumeric characters (identified as Header, Field 1, and Field 2 in the figure), and additional text 110.

Note that one or more of the data fields may be identified by labels, titles, or other form of indicator, and may have a value or text inserted in the field. Note further, that although the “image” shown in FIG. 1(a) is illustrated as being undistorted, the actual image of a subject document may be skewed, rotated, distorted, etc. As will be described, in some embodiments, the processing described may include determining and then applying a transformation to “correct” the image of a subject document to make it able to be more reliably processed and evaluated.

While FIG. 1(a) illustrates an example of a document having certain attributes or characteristics (a logo, a hologram, etc.), documents that may be processed and authenticated or verified using an embodiment of the system and methods described herein are not limited to those having the characteristics of the example. The system and methods described are not limited to processing documents having a specific set of characteristics or attributes and may be applied to any document for which a reliable template or example is available or can be generated.

FIG. 1(b) is a flowchart or flow diagram illustrating an example process, operation, method, or function 120 for authenticating/verifying a document, in accordance with some embodiments of the system and methods described herein. At a high-level, the processing and authenticating of a subject document involves one or more of the following steps, stages, functions, methods or operations:
Receive or access an image of a subject document (step or stage 121);
Identify and/or extract invariable attributes of the subject document (step 122);
   based on the invariable attributes, identify one or more document templates that are likely to represent a document class or type (such as driver's license from state A, identify card from state B, passport issued by country C, diploma from University D, etc.) that includes the subject document, as suggested by “Determine Candidate Template(s)” step 123, which in some embodiments comprises:
      Access Set of Document Templates and Data Describing Invariable Attributes Associated with Each Template; and
      Determine Most Likely Document Templates that “Match” Subject Document Based on Invariable Attributes;
Determine the most likely template (or “best” template) that represents the subject document, such as by generating a score or other metric reflecting the closeness of the match between the set of invariable attributes of the subject document and those of each of the templates that may represent the class or type of the subject document, as suggested by “Determine Template “Best” Matching Subject Document” step 124, which in some embodiments comprises:
   Based on Comparison of Invariable Attributes and/or Font Analysis, Determine Most Likely Correct Template(s);
   For Each of Most Likely Templates (that are likely to represent the same type of document as the subject document), Determine Image Transformation (if needed) to Transform Image of Subject Document into Standard Form of Document Represented by Template (that is, one that is not skewed or distorted); and
   Based on Transformed Examples of Subject Document and Standard Form(s), Invariable Attributes, and/or Font Analysis, Determine/Confirm Which Template is Best Match to Subject Document;
      For example, based on an evaluation of the invariable attributes of a transformed image of the subject document and the invariable attributes associated with each template, identify the most likely template or document type that the subject document represents (i.e., the “best” match between the set of templates and the subject document);
For Template that is Best Match, Access Data Describing Font, Format or Other Requirements for Invariable Attributes and/or Content of Subject Document, as suggested by step 125 (if not already performed);
   A data file or meta-data may include, for example, font types and characteristics for invariable attributes, data formats for information entered into the subject document (such as name, date of birth, serial number, etc.);
Perform a text analysis, such as a font verification process between the selected template and the subject document to confirm that the subject document is a valid example of the document type represented by the template. This serves to compare font, format or other requirements between invariable attributes in a template and the subject document (if not already performed), as suggested by step 126;
   note this does not confirm the contents or personal information in the subject document, only that it is a valid example of the template document, for example by comparing the text associated with a field name or label in the subject document with the requirements or expected characteristics of the field name or label in the type of document represented by the template;
Identify and/extract data or images from the subject document to compare with the attributes and requirements of the template for document content (i.e., information entered, such as a specific date of birth being in a correct font and format), as suggested by step 127;
Perform additional processing on the subject document data and/or images to detect attempts at fraud, confirm information in the subject document (such as by reference to an external database of issued passport numbers), etc., as suggested by “Perform Further AuthenticationNerification Processing” step 128, which in some embodiments comprises:
   If Applicable, Access External Database(s) to Verify Authenticity of Content in Subject Document; and
   Perform Fraud and/or Other Checks or Evaluations;
Generate an evaluation of the authenticity of the subject document based on consideration of the invariable attributes and content, such as a score and/or heat map indicating a level of confidence in the authenticity of one or more attributes (invariable or otherwise) of the subject document, as suggested by step 129;
   If the score exceeds a threshold value, then accepting the subject document and the information it contains as valid; and
   If the score does not exceed the threshold value, then considering other attributes, re-estimating the image transformation or performing other review of the subject document.

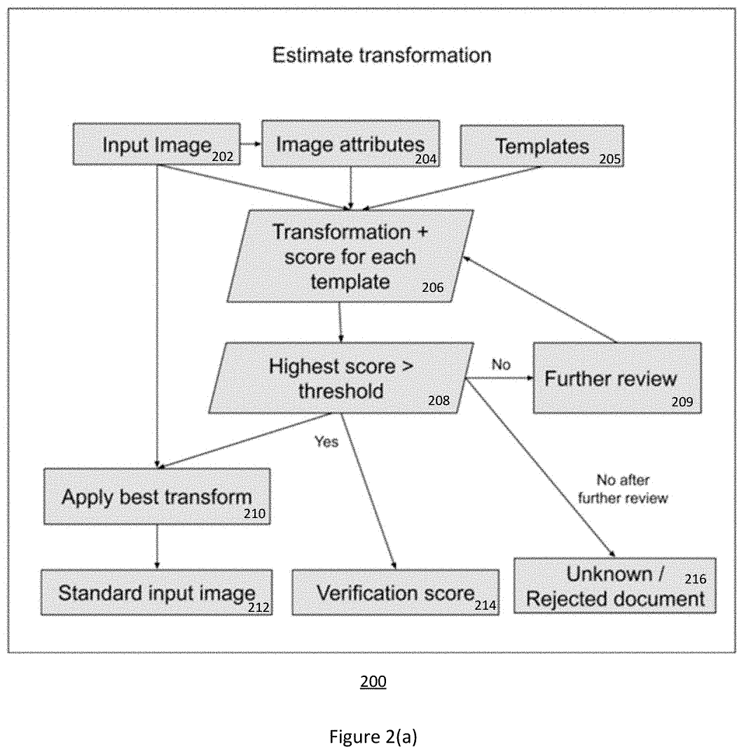

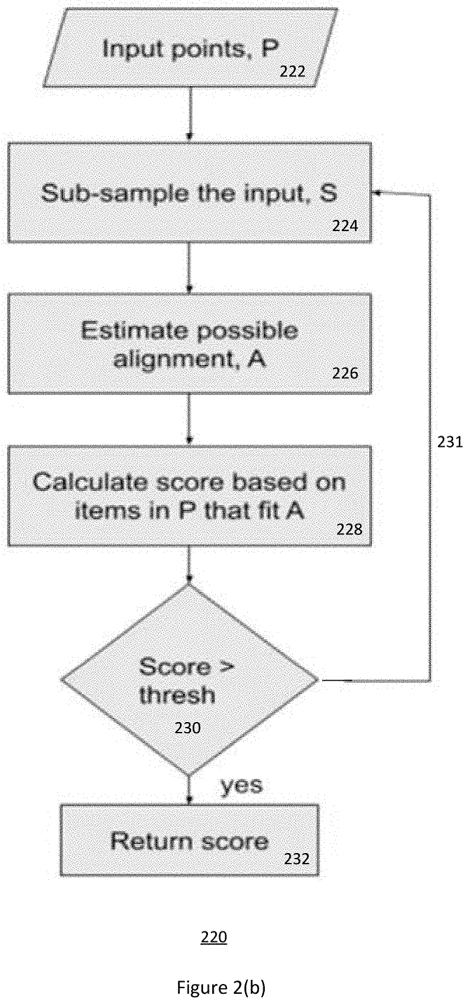

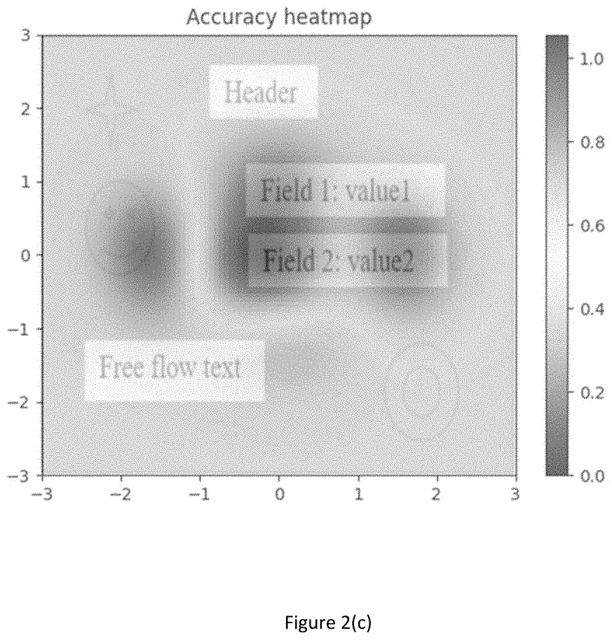

FIG. 1(c) is a second flowchart or flow diagram illustrating an example process, operation, method, or function 130 for authenticating/verifying a document, in accordance with some embodiments of the system and methods described herein. These processing steps or stages may be described in further detail as follows:
Receive or access an image of a subject document (as suggested by step or stage 132)
   as examples, the image may be a photograph, scan or generated by use of an OCR process;
Process the image of the subject document to identify and extract one or more invariable attributes of the subject document (step or stage 133);
   where the invariable attributes may include labels, titles, headers, field names, logos, holograms, seals, or similar features that can be recognized with confidence even if an image is skewed or distorted, and do not represent information or data specific to a person in possession of the document (such as data inserted into a field, a birth date, an address, etc.);
Identifying one or more document templates representing classes, categories or types of documents that may include the subject document, based on a sufficient similarity or match between the identified/extracted invariable attributes of the subject document and the invariable attributes associated with a template or templates (step or stage 134);
   this may include performing a comparison or search for a template or templates that include or are associated with the set of extracted invariable attributes, evaluating the number of attributes that match or are substantially similar, and then generating a decision as to which template or templates are most likely to represent the subject document (step or stage 135);
      if there is more than one potential template that matches or is substantially similar (or none), then other attributes may be examined (step or stage 136), or template selection may be performed after the image transformation step or stage (which may alter the image to provide more accurate identification and extraction of invariable attributes);
Determining/estimating a transformation (if needed) to transform the image of the subject document into a more suitable form for identifying a corresponding template, confirming a possible template, and/or for further processing (step or stage 137);
   examples of possible transformations include, but are not limited to, homography, affine, and rotations;
      the accuracy or sufficiency of a transformation can be evaluated by a sampling process to compare a transformed image to one or more document templates and assist in determining the appropriate transformation(s) to use to produce an image of the subject document that can be reliably processed and/or to determine the appropriate template and hence document type or category of the subject document (an example of a sampling and evaluation process that may be used is described with reference to FIG. 2(b));
Applying the determined/estimated transformation to the image of the subject document (step or stage 138);
   performing a font verification process to determine whether the fonts and font characteristics of the invariable attributes present in the subject document match those expected based on comparison with one or more templates (step or stage 139)—this may involve accessing a file or meta-data associated with one or more templates that provide information regarding the font type and characteristics for the invariable attributes of a template;
      note that at this stage of the processing, font verification may be used to assist in selecting the correct or most likely to be correct template—in other stages of the processing, font verification may be used to detect possible alterations to text or numbers in a document;
   Generating a score or metric reflecting a confidence level or accuracy of the identified attributes and/or the document type (i.e., a measure of the match or closeness of a match to a template) based on the transformation and extracted invariable attributes;
   Determining if the generated score satisfies (typically by exceeding) a threshold value or confidence level;
      If the generated score satisfies the threshold value or confidence level, then classifying the subject document as a specific document type, category, or class (step or stage 140);
      If the generated score does not satisfy the threshold value, then re-evaluating the subject document (rescoring) using one or more of additional invariable attributes, inspection of the subject document by a person, or use of a different methodology to determine the correct document type;
Accessing a file, meta-data, or other form of information associated with the template that is determined to best represent the subject document class or type;
Identifying/extracting one or more fields, data, content, images, or other elements from the subject document image for use in further comparisons and authentication or verification processing;
   in some embodiments, the identified/extracted data from the subject document may represent the data or information contained in the fields associated with the invariable attributes, such as a name or date of birth (step or stage 141);
Performing further processing steps or stages on the identified/extracted data from the subject document to enable its comparison with an expected format (for example, a content format check for date, ID number, address, etc.), where that format may be defined by the file, meta-data, or other form of information associated with the determined template (step or stage 142);
   other processing steps that may be performed in addition to (or instead of) a content format check include:
      font verification (143) to evaluate whether the subject document contains the appropriate font type, font size, and font style for each of its attributes and/or the content;
      fraud detection checks to identify possible tampering or alteration of a document (144);
   in some cases, the identified/extracted data may be transformed or consolidated into a standard format to enable a comparison with available external data sources, and to verify certain data with external databases or sources (where such sources may include government databases for issued licenses or passports, fake ID databases, a database of members of an organization, etc.);
      this verification of (or inability to verify) specific information in a subject document with an external database may assist in determining whether a document of the type the subject document is believed to be was issued to the person whose name, address, birth date and/or image are shown on the subject document;
         for example, this step of the authentication process may determine that while the document itself appears to be genuine, the information on it is not reliable or has been altered to someone else's name or date of birth;
Generating a score, metric or other form of evaluation (such as a heat map) to indicate a level of confidence or accuracy in the authentication or verification of one or more attributes, data or content of the subject document (step or stage 145);
   if the generated score or heat map indicates a sufficient reliability or confidence in the authenticity of the document, then accepting the subject document and the information it contains as accurate for purposes of what the document discloses and for identification of the person presenting the subject document (step or stage 146);
   If the generated score does not satisfy a desired threshold level or confidence value, or a heat map indicates a lower than desirable confidence level, then re-scoring with more attributes specific to the most likely template (if one has been identified) and iterating the processing by performing the image transformation estimation step(s) (step or stage 137) forward (step or stage 147); and
      if the score or evaluation still fails to satisfy the threshold, then rejecting the document and possibly requiring human intervention and other forms of analysis or evaluation.

As mentioned when discussing font verification, in some embodiments, processing of alphanumeric elements of a document may be performed, either alone or in combination with the image processing. The font verification process may be performed as part of, or instead of, certain of the processing steps described (fraud detection, content format checks, etc.). Font verification can be used to help identify altered or forged documents, particularly where a valid document would be expected to have specific fonts, font sizes, font styles, etc. for a document attribute or content (such as for a specific label or field name, or for an entered date or identification number, etc.). As mentioned, font verification can also be used to assist in identifying the most likely template that represents a subject document by providing additional information that can be used in a comparison between a subject document and the invariable attributes of a document type.

In some embodiments, a document whose authenticity is to be determined is received or accessed, typically from a person or data storage element. If needed, the person may provide an image of the document using a camera, scanner, or similar device. A set of invariable attributes of the document are identified and extracted. In some embodiments, invariable attributes refer to characteristics or data (e.g., the words Name, Signature, DOB; logos; holograms, field labels, etc.) that are found in a class or category of documents and are a part of all documents in that class. For instance, these may be field names, labels, titles, headings on a document, etc. They are also attributes or characteristics that may often be identified with sufficient accuracy and reliability even if an image is skewed or slightly distorted.

The extracted invariable attributes are compared against the attributes for a set of templates, with each template representing a type or class of documents (such as a driver's license issued by state A, a passport from country B, etc.). This typically means that an initial set of invariable attributes are used to determine one or more templates that might correspond to the subject document being processed. In most cases, a small set of invariable attributes, for which there is a relatively high level of confidence with regards to their identification, are used to find one or more templates that contain those attributes. If the set of attributes match those contained in more than one template, then other attributes may be extracted until one or a small set of candidate templates are identified. At each stage of comparing attributes from a subject document to a template, a metric or measure of the similarity between the subject document and one or more templates may be generated based on the set of attributes, with the metric or measure being evaluated to determine if the process will accept a particular template as being the correct (or “best”) one to represent the type or category to which the subject document belongs.

In some embodiments, each attribute of a template is associated with a confidence level or metric. This determines the attribute's contribution to the score for a subject document should the attribute be present in the subject document. As examples, attributes might be labels or titles in a document, logos, faces, holograms, seals etc. that are expected to be present in a document belonging to the class or type represented by a template. Some attributes are searched for at specific locations in a subject document, while others (such as seals) may be assigned a score without considering their position in a subject document.

Common attributes that are present in a number of templates (for example, the text “Driver's”, “US”, “License” etc.) may be assigned lower confidence levels, while more unique attributes (for example, seals, logos, a state name such as “UTAH”, country codes etc.) are given higher confidence levels. In this way, the confidence level represents a measure of the commonness of an attribute among a group of templates and results in giving less weight to the most common attributes when deciding which template or templates best represent a subject document.

A template may contain or be associated with template-specific processing information to assist in extracting additional attributes or otherwise processing a subject document. This processing information may include an indication of a watermark, faint background text, etc. The additional attributes may be used when the more easily extractable attributes are not sufficient to determine a subject document's “best” associated template with sufficient confidence. The additional attributes are typically given higher confidence levels as they are often unique to a specific template class.

As part of identifying the correct or most likely to be correct template, the image being processed may be subjected to a transformation or set of transformations in order to enable it to be more accurately matched to an image in a template and/or to be used more effectively for subsequent stages of document processing. This may be helpful in the situation where an image is skewed or distorted. One or more transformations may be applied to the image of the subject document, with the result of each being evaluated or scored against each possible template (e.g., those containing the invariable attributes extracted from the subject document) to determine the transformation or transformations to apply to generate an image of the subject document in a form that is closest to the standard form of an image of a document type associated with one of the templates.

In some embodiments, the determined transformation or transformations are applied to an image and along with the number of matching invariable attributes, are used to generate a “score” to determine whether the document “belongs” to the class (or document type) represented by a given template. If the score or scores developed at this stage of the processing are inconclusive, then the score may be recalculated after additional template-specific steps, including, but not limited to fraud detection (checking the authenticity of specific attributes), font type verification (which is of value in confirming the authenticity of ID and other types of documents), quality detection (detecting evidence of tampering, wear and tear), and/or format verification (e.g., checking if the date is in the format the document is expected to use) to obtain a revised verification score. The “further review” process described herein may also (or instead) be used to recalculate and improve scores using knowledge of the template document to detect and enhance additional template-specific attributes.

In the case where the input image is of lower quality, it is possible that none of the templates results in a reliable enough match. In this situation, a further review step is performed, wherein the most likely template candidates are identified, and one or more computationally intensive (in a relative sense) template-specific processing operations are performed, after which the image is scored again, and the transformation estimate is re-calculated. The template-specific operations that may be applied as part of this processing include, but are not limited to, template specific background artefact removal, background text removal, logo detection/matching, text enhancement etc.

As mentioned, as part of the document authentication/verification processing, a transformation or transformations may be applied, where the transformation may be used to convert the original image of the subject document into a standard format so that it is easier and more accurately represented for further processing. FIGS. 1(d)-1(f) are diagrams illustrating three example possible transformations (homography, affine and rotation, respectively) that may be applied to an image of a document as part of an authentication/verification process, method, function or operation, in accordance with some embodiments of the systems and methods described herein.

FIG. 1(d) illustrates an example of a homography transformation. A homography is an isomorphism of projective spaces, induced by an isomorphism of the vector spaces from which the projective spaces derive. It maps lines to lines and is thus a collineation. A homography transformation contains 8 degrees of freedom and typically requires use of at least 4 attributes (x,y). It may be represented as an operator matrix, S, acting on a vector

$$S [ \begin{matrix}{x}^{′} \\ {y}^{′} \\ 1\end{matrix} ] = [ \begin{matrix}h 11 & h 12 & h 13 \\ h 21 & h 22 & h 23 \\ h 31 & h 32 & h 33\end{matrix} ] [ \begin{matrix}x \\ y \\ 1\end{matrix} ]$$

FIG. 1(e) illustrates an example of an affine transformation. An affine transformation, affine map or an affinity is a function between affine spaces which preserves points, straight lines and planes. Sets of parallel lines remain parallel after an affine transformation. An affine transformation does not necessarily preserve angles between lines or distances between points, though it does preserve ratios of distances between points lying on a straight line. An affine transformation contains 6 degrees of freedom and typically requires use of at least 3 attributes (x,y). It may be represented as an operator matrix, S, acting on a vector:

$$S [ \begin{matrix}{x}^{′} \\ {y}^{′} \\ 1\end{matrix} ] = [ \begin{matrix}a 11 & a 12 & a 13 \\ a 21 & a 22 & a 23 \\ 0 & 0 & 1\end{matrix} ] [ \begin{matrix}x \\ y \\ 1\end{matrix} ]$$

FIG. 1(f) illustrates an example of a rotation or rotational transformation. A geometric rotation transforms lines to lines and preserves ratios of distances between points. A rotational transformation contains 4 degrees of freedom and typically requires use of at least 2 attributes (x,y). It may be represented as an operator matrix, S, acting on a vector:

$$S [ \begin{matrix}{x}^{′} \\ {y}^{′} \\ 1\end{matrix} ] = [ \begin{matrix}cos ∅ & - sin ∅ & 0 \\ sin ∅ & cos ∅ & 0 \\ 0 & 0 & 1\end{matrix} ] [ \begin{matrix}x \\ y \\ 1\end{matrix} ]$$

FIG. 1(g) is a block diagram illustrating the primary functional elements or components of an example workflow or system 150 for authenticating/verifying a document, in accordance with some embodiments. As shown in the figure, an image of a subject document is input to the processing workflow or pipeline (as suggested by step or stage 152). The processing identifies and extracts invariable attributes of the document in the image (as suggested by step or stage 154). A transformation of the image is estimated that will operate to transform the image into a standardized form (158) for further processing (as suggested by step or stage 156) and/or for more reliable comparison with a template or templates. The transformation is based, at least in part, on the set of invariable attributes extracted from the subject document and comparison with those in each template of a library of templates (159), with each template representing a possible type or category of documents. A verification score (160) may be determined or calculated which provides a measure or metric representing a likely match or degree of similarity between the subject document and one or more of the possible document templates. Note that in some embodiments, a font verification process may be performed as part of matching the subject document to a template and/or as part of verifying the authenticity of the subject document (as each template may be associated with specific fonts or font variations for certain labels or fields).

If the score or metric is not sufficient to meet a threshold of reliability or confidence level, then the transformation, the assumed correct template or both may be subject to further review (step or stage 162) to identify additional possible attributes for extraction and consideration (step or stage 164). This may lead to a re-estimation of the transformation, generation of a revised standardized image, and a re-scoring of the subject document with regards to one or more templates in the set of templates.

After the subject document has been associated with a template with a sufficient degree of confidence, other aspects of the subject document may be identified/extracted and subject to verification (step or stage 166). This may include content such as a person's name, address, date of birth, driver's license number, or other information that is expected to be unique to a particular subject document. The extracted information may be checked or compared to information available in a database or data record as part of verifying the information, and hence the subject document (as suggested by database checks 168). Additional verification processes, including fraud checks (169) and/or font verification may be performed to further authenticate the subject document and the information it contains.

As described, in some cases an image of a subject document may be operated upon by one or more transformations in order to assist in identifying a correct template and/or to generate a version of the image that is closer to a standardized form of a template document. This assists in further processing of the subject image, such as for font verification, fraud detection, etc. The selection of which transformation or transformations to apply to an image of the subject document may be determined by a process described with reference to FIGS. 2(a) and 2(b).

FIG. 2(a) is a flowchart or flow diagram illustrating an example process, operation, method, or function 200 for estimating a transformation that may be applied to an image of a subject document, in accordance with some embodiments of the system and methods described herein. As shown in the figure, an image of a subject document (202) is obtained and input to the processing workflow or pipeline. Attributes of the image (204, typically invariable attributes of a document) are identified, extracted and provided to a transformation engine (206). A library of templates (205) is also provided to, or is accessible by, the transformation engine.

In some embodiments, transformation engine 206 operates to determine a possible transformation or set of transformations to apply to the image of the subject document to produce an image that represents a document belonging to a class or type represented by one or more templates. Transformation engine 206 may also operate to generate a score or metric representing the closeness of a transformed image of the subject document to each of one or more templates. The highest score may then be compared to a threshold (208) to determine if the score exceeds the threshold, and hence that one of the possible templates is sufficiently likely to represent the category or type of the subject document. If the score is sufficient to meet or exceed the threshold, then that transformation is applied to the input image (210) to generate a standardized image of the subject document (212). A verification or authentication score may also be generated for the document (214), representing the confidence level in that subject document belonging to a particular class or type of document (that is, being an example of a specific template).

If the score(s) reflecting the closeness of a transformed image to the possible templates do not exceed the threshold value, then the subject document may be rejected as being unknown or unable to be authenticated (216). In some cases where the score reflecting the closeness of a transformed image to the possible templates does not exceed the threshold value, a further review process (209) may be used that may include human visual inspection and evaluation of the image of the subject document.

In some embodiments, the threshold value may be determined (at least in part) based on the collection of template classes being considered as possible “matches” to a subject document. For example, if the template classes are composed of mostly unique attributes, a lower threshold value may be used. In a situation where the template classes are more alike (for example, two templates of driver's licenses from the same state, one an older version and the other a more recent version), the thresholds may be set higher in order to prevent a subject document being misclassified into a similar (but ultimately wrong) template. In this sense, one purpose of the threshold value is to ensure that the highest scoring template (i.e., the template most likely to represent the same type of document as the subject document) out of the set of considered templates is not a misclassification.

In some examples, the threshold value may be adjusted based on an end user's tolerance, which may reflect the significance or risk if an error should occur. For example, a grocery store verifying pickups would likely have a higher tolerance to errors (a misclassification of an older version of a proof of purchase as a newer version might not be a significant issue or would be easily correctable), while a banking application might require stricter thresholds to better protect against fraud or liability.

As part of determining or evaluating whether a particular image transformation has produced a sufficiently close “match” to a document template, the accuracy or sufficiency of a transformation can be evaluated by a sampling process. In some embodiments, a sampling process selects points in the transformed image for comparison to points in regions of one or more document templates. Depending on the number of attributes recognized, different skews or distortions of an image of the subject document can be corrected to make the resulting image look more similar to a standard, un-skewed or undistorted image of a document represented by a document template.

In order to determine the transform matrix or matrices to use to perform the transformation and standardization operation, several different types of transforms may be considered. Since the use case of document authentication and verification is expected to involve similar attributes occurring in a variety of documents and document types, an outlier resistant estimate process is expected to work well and can be used to identify the most likely to be correct transform or set of transforms. Outlier resistance is a feature or characteristic that assists in a process being resistant to detection inaccuracies and false positives in the attributes.

FIG. 2(b) is a flowchart or flow diagram illustrating an example process, operation, method, or function 220 for generating a confidence score for a subject document with respect to a possible template based on a sampling of points in a transformed image, in accordance with some embodiments of the system and methods described herein. The figure illustrates an outlier resistant estimating processes, in this example the Random sample consensus (RANSAC) process which may be used to generate a verification score or confidence criterion for a set of data from a subject document with respect to a possible template.

RANSAC is an iterative method to estimate parameters of a mathematical model from a set of observed data that contains outliers, when outliers are to be accorded no influence on the values of the estimates. Therefore, it also can be interpreted as an outlier detection method. During each iteration, a percentage of the input points (P, as represented by 222), are sampled (S, as suggested by step or stage 224) and then an image transformation is calculated based on the sampled set of points (226). Once the transformation is calculated, it is scored against the entire set of points, P (as suggested by 228). A score is determined based on the number of input points, P that fall within the margin of error of the fit. If too many points fall outside the margin of error (outliers) or if the score falls below a certain value (such as a confidence or accuracy threshold), then the transformation is re-estimated for a new set of points (as suggested by 230 and iterative feedback loop 231). A score is returned once a good enough fit is found or a sufficient number of iterations have been tried (as suggested by 232).

Note that other methods may be used to evaluate the accuracy or closeness of an image transformation. These include a Theil-Sen estimator, and L1 or L2 regression. However, each of these alternatives have disadvantages. A Theil-Sen estimator, while robust to noise, is computationally intensive compared to RANSAC while delivering comparable accuracy for the use case being considered. The regression methods, while faster, are not as robust to outliers as RANSAC.

In some cases, it may be helpful to understand the relative degree of confidence the processing has resulted in for one or more elements or attributes of a subject document. This can be useful in identifying the effectiveness of the processing and/or identifying elements or attributes that may require further processing or analysis. FIG. 2(c) is a diagram illustrating an example of a “heat” map representing a confidence level in the accuracy of one or more attributes extracted from a subject document, and provides a visual indication of the verification accuracy of regions of a document subjected to processing by embodiments of the system and methods described herein.

The confidence map provides a visual indication of the verification accuracy of regions or aspects of a document. The heat-map can be used to illustrate regions with artefacts such as blurriness, regions with glare/hologram reflections, or areas where the content (logos, font and color of text etc.) don't match the expected content. In many cases, such a heat map provides an easier way to understand aggregate information. For example, if an OCR of a subject document has consistent issues with a date of birth due to background artefacts, a heat map can highlight this problem. Further, regions of recurring errors can be compiled and checked as part of suggesting potential improvements to the image processing workflow or pipeline.

For example, improvements to the processing workflow may include but are not limited to, gathering additional training data for a new OCR model (i.e., one that might contain the date of birth with artefacts) so that the OCR accuracy is improved for the determined scenarios, specific image processing to remove or reduce the artefact (screening out background patterns, removing certain colors etc.), providing feedback to the document provider regarding glare or blurry regions in the document and requesting a better version of the document, improving the image capture mechanics so that the blurry document or glare scenario doesn't occur or is reduced, etc.

As has been described, in some embodiments, processing of alphanumeric elements of a document may be performed, either alone or in combination with the image processing. The alphanumeric elements may be processed by a font verification process, which can be used to identify altered or forged documents, particularly where a valid document would be expected to have specific fonts, font sizes, font styles, etc. for specific document attributes. Font verification may also be used to more confidently identify which of several possible document templates is a closest match to a subject document. In that usage of font verification, it may be applied after determination of a transformation to apply to an image of a subject document.

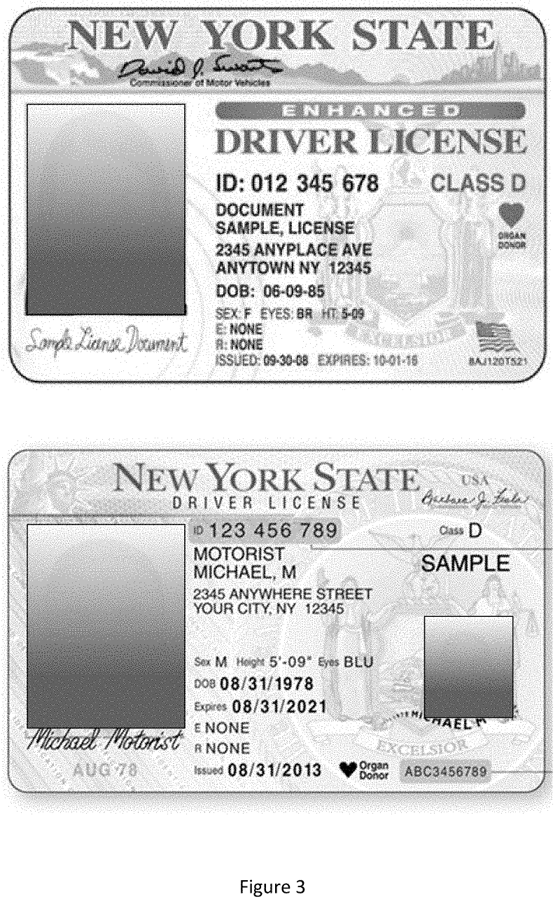

As can be seen in the examples shown in FIG. 3, different identification documents from the same state may use different fonts, and a single document may use different fonts for different attributes. For example, the older identification document (the upper one in the figure) uses the Helvetica Bold font for the majority of attribute values, while the newer document (the lower one) ID on the right uses a mixture of Arial and Helvetica Condensed Bold fonts.

Knowing the correct font that should be used for a specific attribute value assists the fraud detection or template selection workflow to extract precise attribute values from raw OCR results. In some embodiments, this is done by partitioning the set of returned characters into those that conform to the font and those that do not. In the lower example, the characters “OB” in the field name “DOB” can potentially be read by an OCR engine as “08” and joined with the rest of the line to result in a highly ambiguous string “0808/31/1978”. However, using the fact that the characters “0” and “8” are typeset in a different font, the process can recover the original value, “Aug. 31, 1978”, without ambiguity.

Including modeling of attribute fonts in the document processing also helps to detect possible fraud by comparing the expected rendering of the attribute value against the actual rendering of the value. As can be seen in the lower image, the appearance of the character “3” in the address field is considerably different from the appearance of the same character in the DOB field, since the two fields use Arial Regular and Helvetica Condensed Bold fonts, respectively. The difference between the two data items at the attribute level will be more pronounced, since different fonts use different amounts of space not only for single characters but also between pairs of characters (i.e., kerning). This means that renderings of the same attribute value in different fonts may have notable differences at the pixel level.

Font recognition is one form of font processing that seeks to recognize a font type from an image. Existing publicly-accessible websites for font recognition include MyFonts/WhatTheFont, Font Squirrel, and Font Finder. Available open-source font recognition systems include DeepFont and TypeFont; however, their performance has generally not been satisfactory for practical application, especially in noisy scenarios.

In contrast to these generic font recognition systems, the font verification processing or service described herein operates to assure that the font type and/or characteristics specified by a document template or attribute model are present in the subject document and used for rendering the attribute value. In this sense, the system performs model-based font verification rather than generic font recognition. This is a distinction between the system described herein and conventional systems, both in terms of implementation and performance.

In some embodiments, when creating a document-specific model of the font type and font characteristics of an attribute, the workflow starts with a number of documents of the same type or category. This set of documents may be determined by the image processing workflow described. Using the image processing workflow, a set of documents that are believed to be the same type or category are selected. Next, the OCR results and a search process are used to fit a set of possible fonts to each attribute. This may be done by comparing attribute renderings to the images. The system selects the best overall match after computing aggregate scores over multiple documents. In the case that a suitable match is not found, a human expert may be consulted to find the unidentified font or to design one from scratch.

The described font verification workflow benefits from one or more of the following characteristics. First, due to the image processing workflow, the system is able to recognize document types prior to performing document-specific attribute-based font verification. Second, document templates built for determining document types limit the scope and requirements of the font verification system. Third, image segmentation and character-level and attribute-level image alignment algorithms may be used to ensure that rendering the attribute value in the proper font results in a higher score or metric, while rendering the same value in a different font results in a lower score. This multi-stage approach results in a higher accuracy rate for document identification and verification. In contrast, conventional systems use unconstrained font recognition, which results in much lower accuracy for images that feature noise and multiple fonts, as is the case with identification and other classes of documents.

The font authentication/verification processing described verifies that the font and/or font characteristic used for a specific document attribute in a subject document is the correct and valid one. Note that this may be a font used as part of a label, title or field name for an invariable attribute and/or a font used as part of content in a document (such as a birth date or identification number). In some embodiments, the font verification is performed by automatically building a context-specific font model offline and applying the model at runtime when a subject document is processed. This approach has been found to work well in those scenarios where available examples of attribute values have a consistent font, which is the case for many identification documents and certain other categories of documents. In the case of an attribute value resulting in a low likelihood of a match or a relatively low accuracy score, it will typically be indicative of either (1) poor OCR results, (2) suspected fraud, or (3) a document template mismatch. Any of these cases will cause the system to “flag” the entry for additional inspection and improved overall system performance.

In some embodiments, a font verification service may perform one or more of the following functions, operations or objectives:
1. Learning font attributes (i.e., font characteristics or constraints) for each combination of ID (or document) type and attribute. Font characteristics or constraints may include one or more of the typeface (e.g., Arial), its variation, (e.g., Bold), the aspect ratio, and the kerning (extra positive or negative space between pairs of characters);
2. Learning the separator constraints that indicate a word separator, such as “/” (slash), and the maximum number of separators, such as 2 for the date of birth (DOB) field;
3. Extracting usable attribute values from OCR processing of document images by applying the font and the separator constraints and by adding missing characters and word separators;
4. Detecting if OCR results are unreliable, due to the presence of image defects, such as glare, holograms, low resolution, or motion blur;
5. Indicating potential fraud where apparent, by ensuring the correct appearance of attribute values in terms of the font, spacing, and size; and
6. Providing feedback to the image processing workflow when potential image defects or document alignment issues are present to assist in modifying the workflow;
   a. if the font verification service fails to match text to the image of the subject document (or does it with an insufficient confidence level or accuracy) due to glare, blurriness, or low contrast, these factors can sometimes be overcome by either selecting different frames from a video or by asking the user to change their imaging conditions. This can provide a clearer image of the document, which improves the accuracy of other parts of the processing workflow as well.

In some embodiments, the document processing system or service described herein may be implemented as micro-services, processes, workflows or functions performed in response to the submission of a subject document. The micro-services, processes, workflows or functions may be performed by a server, data processing element, platform, or system. In some embodiments, the document evaluation, authentication, or verification services and/or an identity verification service may be provided by a service platform located “in the cloud”. In such embodiments, the platform is typically accessible through APIs and SDKs. The font verification and image processing services may be provided as micro-services within the platform. The interfaces to the micro-services may be defined by REST and GraphQL endpoints. An administrative console may allow users to securely access the underlying request and response data, manage accounts and access, and in some cases, modify the processing workflow or configuration. The font verification/authentication processing aspects may include one or more of the following data stores, functions, components, processing workflows or elements:
1. A set or collection of licensed typefaces that are used for rendering attribute values. These typefaces may be obtained from paid and free sources, such as font foundries. Typefaces that are not possible to source directly may be created by a typeface designer;
2. A component that operates to determine pixel dimensions of characters (for each font) by rendering the characters as binary images and computing the minimum bounding rectangles;
3. A set of font configuration files, one per attribute per document template, that include for that attribute in that template, one or more of:
   a. the font name, such as Arial Bold;
   b. a range of acceptable font sizes, in pixels;
   c. the aspect ratio;
   d. the kerning (extra positive/negative space between characters);
   e. the word separator (such as “/”); and
   f. the maximum number of separators;
4. A character segmentation component that operates to separate characters from the background inside its bounding box to obtain a binary (black and white) image, with the white (all bits set to 1) portion representing the foreground character and the black (all bits set to 0) portion representing the background (this may be done to better accommodate the subsequent use of binary image matching algorithms or methodologies);
   a. note that a benefit of this approach or implementation is that it can use most existing segmentation algorithms for the task;
      i. example methods that may be used include Otsu's adaptive thresholding, Stroke Width Transform, and ML-based segmenters;
   b. in the cases when a character is not effectively separated from its neighbors, the system may apply additional segmentation methods;
      i. for example, the initial Otsu threshold may be adjusted to achieve proper separation;
5. A text rendering component that operates to render characters and words in a specific font using the OTF or TTF file formats or representations of the font;
6. A character matching component that computes an “optimal” or best match between a character's segmented image and its rendering by varying the size and the location of the rendering to find the combination that produces the best match between the two. Examples of metrics that may be used to compute the similarity between a binary segmentation and a binary rendering include Jaccard similarity, convolution similarity, and Hausdorff distance. As an example of the similarity determination and optimal matching process:
   a. to compute the similarity of a specific overlay, replace all white pixels with 1 (or a similar positive number), replace all black pixels with −0.25 (or a similar negative number), then compute the convolution (the sum of products of pixel values) normalized by the area of the smaller rectangle;
   b. determine the optimal font size (in terms of pixels) and location per character;
   c. if there are regions whose size exceeds a threshold (that may be determined based on the optimal F1 score) where there is no overlap between the segmented image and the rendering, declare a mismatch;
   d. characters whose estimated font size is below a threshold are also typically discarded;
7. An effective font size component that uses the first few matching characters to determine the expected size of characters in terms of pixels;
   a. small characters that correspond to field titles may be discarded;
   b. separators, such as spaces and commas, may be excluded from the process;
   c. determine the median of the font size of the first few characters whose match value exceeds a threshold;
8. A character scoring component that uses the effective font size computed previously to calculate new/updated character matching scores. In effect, this repeats one or more portions of the matching process from step 6, except that the font size is limited to a small range and it varies the location;
9. A rotation angle component that uses matching characters for determining an optimal rotation angle. Although the exact rotation angle is relatively unimportant for character matching, it is important for attribute matching. This is because the rendering of an attribute value will not correctly intersect with its image if the attribute value is more than 2 characters long and the angle is incorrect. In one example embodiment, an algorithm uses search to find the optimal angle but other methods, such as spatial transformer networks, are also expected to work well under the constraints of the use cases considered:
   a. the union of matching characters is a binary image, with matched pixels having intensity 1 and the background pixels having intensity 0;
      i. viewing a rectangular binary image as a 0-1 matrix, a row sum corresponds to the number of white pixels in the row;
      ii. rows with a non-zero row-sum indicates the presence of at least one character;
   b. an optimal rotation angle is the angle that minimizes the number of rows with non-zero row sums, since it corresponds to the thinnest horizontal stripe that fully contains all characters;
      i. due to possible image noise, using a small threshold value (such as 8) to ignore rows having more than that many non-zero entries helps improve finding the optimal angle;
      ii. the optimal rotation value can typically be found by search in the range of −5 to 5 degrees—this efficiency is a result of the effectiveness of the image processing stages;
10. An attribute segmentation component that separates the image pixels of the attribute from the background pixels. To avoid a potential problem based on contrast differences, in some embodiments, this component uses the union of the segmentations of characters that were previously matched (or characters between such characters) rather than applying a global image segmentation method;
11. An attribute matching component that aligns the segmented image of an attribute and its rendering by varying the size and the location of the rendering in a process to find the combination of size and location that produces the best match between the segmented image and rendering. See the character matching process described above for further details. As part of this attribute matching;
   a. assume that the font and its characteristics (such as the aspect ratio and the kerning) are correct;
   b. assume that the correct rotation angle has been determined;
   c. since the prior character matching component has determined the range of font sizes, only vary the font size within that range;
   d. only render those characters that either were previously matched or are between characters that were previously matched, to avoid matching characters that belong to field labels (on the left) or to the background imagery (on the right), or other undesirable OCR results;
   e. when a possible optimal match is found, if there are regions whose size exceeds a threshold value (typically determined based on the optimal F1 score) where there is no overlap between the two, assume a mismatch and do not use the result;
12. An attribute modification component that tentatively inserts and removes separators, such as spaces and commas, to allow a determination of whether the resulting rendering will result in a higher matching score when compared to the attribute's image;
13. A match value combination component that combines match values for multiple OCR engines (for example, Kraken, Tesseract, or Google Cloud Vision) to form a final result. Similar to the outputs for the individual OCR inputs, the combined result contains match values for individual characters and attributes, and includes the possibility of an empty match; and
14. A configuration generation component that uses the clearest images with consistent OCR results to assemble the per-template per-attribute configurations described above. This may be accomplished by the following:
   a. use OCR results to extract candidates for word separators (the full set of potential word separators typically consists of 5 characters:
      i. “,”, “.”, “−” “/” “ ”;
   b. use an existing collection of fonts that includes candidates such as Arial Regular, Arial Bold, etc. to find the best-matching one as described below;
   c. define an overall matching metric as a composite (weighted average) of character matching and attribute matching, with the weights determined (at least in part) by the optimal F1 score;
   d. for each potential matching font, compute the best-matching combination of kerning and aspect ratio by performing a grid search in the 2-D space;
      i. perform this grid search operation on multiple (for example, 5) random subsets of clear images to generate multiple combinations of font, kerning, and aspect ratio;
      ii. among multiple combinations that have sufficiently close matching scores, choose the one that is the most parsimonious, i.e., the one that uses the fewest total number of digits after the decimal point to describe kerning and aspect ratio; and
   e. in the case when the maximum combined match value is relatively low (e.g., due to the fact that none of the fonts in the available collection match or are close enough to the actual font), the corresponding images may be examined by a specialist who will add a standard font to the collection or design a brand new one to match the appearance.

As has been described, the construction of document type or category templates and the accurate comparison of one or more templates to a subject document are important aspects of the image processing workflow and authentication processing. The following provides additional details regarding an example implementation of certain elements, components, stages or functions of an embodiment of the systems and methods described herein for use in document authentication and verification.

### Template Definition and Creation

A template can be considered an aggregate of the possible attributes present in a document of the type or category represented by the template (or at least those being used for purposes of a form of document verification/authentication). A template also typically includes an additional set of attributes (some of which are described in the template creation section below) specific to the document class represented by the template and that may be used as part of a “further review” process. The template may also contain or be associated with information that provides suggestions on pre- or post-processing of a document that is believed to be an example of a class represented by a particular template. The template may also contain or be associated with information regarding how a standardized (that is, un-skewed, un-distorted or unaltered) image should appear, so that a skewed or otherwise distorted input image can be transformed into a more usable image, where the image may be represented by a standard image format, such as jpeg, png, pdf, etc.

In some embodiments, a template for a document class, type or category may be created from a standard reference document (of a specific class or type) that specifies and provides an example of the features, requirements or constraints for a given document, and the values each field in the document can take (and the format of those values, if applicable). For example, the date of birth (DOB) being in a specific position in a specific format, a person's picture in a specific format, etc. These “constraints”, characteristics, or requirements are examples of attributes that are checked when classifying an example input document as to whether it belongs to a particular template or class. In some cases, a standard reference document may be obtained from an issuing agency or by using a known valid example of a document type.

In a general sense, a template and its associated files or meta-data may include:
Information specific to a particular document type/class (attributes, scoring, extraction points, thresholds, fraud detection mechanisms etc.);
“Further Review” stage suggestions;
Indications of pre and/or post processing that may be recommended for subject documents to better associate them with the particular template, where:
   pre-processing operations may include one or more of:
      background color suppression, foreground color enhancement, sharpness, brightness white balance changes, etc. that may improve OCR accuracy in documents with a watermark; or
      contrast enhancement—white balance normalization that could improve face, logo detection or recognition by standardizing the image's lighting conditions;
   post-processing operations may include one or more of:
      scoring changes, detection of fraud attempts, extracting data formats, color profiles, fingerprints and further review suggestions;
      removing false positives in detection based on statistics (a lower scoring face detected elsewhere could be screened out, or background text detected in a document can be removed based on the size of the detected text as compared to the expected document font size); or
      cleaning up OCR errors—for example, a ‘$’ sign detected could be replaced by ‘S’ when the document is not expected to contain symbols.

The template may include or be associated with a set of pre- or post-processing techniques and associated thresholds, and/or flags for each of the techniques in order to tailor the processing workflow to a specific template. For example, a template of a document with a red background might include “color removal” as a pre-processing step and the specific color to be removed (in this case red) as meta-data associated with the processing. While implementation of the color removal step is common to templates that request such processing, the specific color to be removed is template specific and alters the output of the processing.

In some embodiments, a template can be created with a single clear and known to be valid image of a document type. In this process, a sufficiently good image of a document is acquired and aligned (either automatically using the corners of the document or manually) to give a template image. Next, the system may perform one or more of the following:
one or more detection mechanisms (OCR, faces, logos, holograms, etc.), are applied to the image to detect the possible attributes present in the template;
   in the case of OCR, a set of keywords is predetermined and only those keywords are qualified as attributes. Keywords are typically something that is not PII (personally identifiable information) and repeats across documents belonging to the same type or category, for example: the words Name, DOB (date of birth), Expiry (date of expiration), Signature, etc.;
other attributes, faces, logos, etc., are automatically detected using a detector/classifier or can be manually tagged by selecting a region in an image as an anchor (this may be compared with an incoming subject document for alignment and verification);
the weights for attributes of a particular detection mechanism may be predetermined based on the reliability of the particular mechanism and its accuracy of detection and/or the significance of the attribute:
   for example, a must be present field such as a face on an ID card will have a higher weight, 1 as opposed to an optional donor symbol which indicates whether the person is an organ donor or not (and may be assigned a weight of 0.5);
the attributes may be manually verified and adjusted if needed in order to finalize the set of document/template attributes;
attributes that may require relatively greater computational resources to detect and/or verify may be considered as “further review” attributes; these may include, but are not limited to aspects such as watermarks, background patterns, curved printed texts in IDs, etc. (that are otherwise difficult or computationally intensive to detect). These attributes may be considered and scored when the subject document image has a lower score (due to blur, tampering, wear and tear, etc.) and additional attributes are needed to more reliably determine the authenticity of the document. This two-stage approach speeds up verification, as most cases don't require analysis of the more computationally intensive attributes; and
the template is then tagged or associated with the pre-processing/post processing that may be necessary to result in a reliable (or reliable enough) detection of attributes, where the pre- or post-processing steps or stages may include one or more of the types described.

Typically, 20 to up to 100 attributes are extracted for verification (or template construction). Note that conventional methods use a single classifier (which is not as reliable) or a barcode reader (which can be easily spoofed by generated bar codes).

As described, in some embodiments, the attributes of a document may include, but are not required to include, or be limited to:
headers, labels, field names, titles, logos, OCR text, text patterns (regular or expected phrases or expressions), faces, signatures, watermarks, holograms, other elements with a position estimate;
   these could be static with respect to the document or dynamic/free flowing;
   characteristics of an attribute may include position, detection confidence, scoring weights, static/dynamic margins.

The processing workflow and methods described herein combine multiple modes/types of data to generate a score based on scoring weights. As described previously, relative weights for different attributes are associated with a template. If an attribute in a subject document is matched to that of a template, then the confidence level of the template's attribute is added to the score for the subject document. As described, a detector, template matcher, or OCR processing may be used to identify a document's attributes.

In one embodiment, a Score, S=Σ Wmatching_attributes/Σ Wall_attributes, where matching attributes are the ones detected by a probability, P above a certain threshold value, T:
the threshold value may vary depending on the modality of the attribute and the detection mechanism used. For example, a face detection might have a certain threshold to be considered accurate while an OCR text could have a different threshold;
another aggregation process, followed by a normalization mechanism, would also be expected to be suitable for scoring, e.g., S=Σᵢ Wᵢ*Pᵢ/Σᵢ Wⱼ, where W is the weight and P is the probability of individual detected attributes being accurate.

As described, after the invariable attributes are extracted from an image, one or more transforms can be applied to convert the input image of the subject document into a “standard” format so that it is more suitable for further processing, such as performing additional checks, information extraction, font verification, fraud detection etc. An image of the subject document may contain non-standard skews and rotations which can be eliminated by a suitable transformation step or steps, resulting in a standard input for the processing stages that follow.

### Further Review Stage

Each template may be associated with an intermediate threshold value or range for the confidence score. In some embodiments, an intermediate value may be determined based on the number of further review attributes and their associated confidence levels. It is desirable that the intermediate threshold value is such that, when the further review attributes match and are added to the score during a re-scoring, the subject document can pass the original threshold and is considered a match to the template. For these scores or scores in this range, a subject document may be subject to a further review stage;
a document that scores below this threshold score or range may be considered to not match the template;
the further review stage may involve template-specific detections, checks, fraud checks to provide additional attributes and re-score the document; and
this processing stage may help to verify inputs that are not clear enough and require additional processing.

### Attribute Identification/Extraction Stage

Once a standardizing transformation has been estimated and applied to the image of a subject document, specific attributes of the subject document (such as its person-specific content) can be identified/extracted:
these might include personally identifiable information (PII), signatures, holograms, tags etc.;
the extraction stage may include additional post-processing steps to transform or translate the document elements into a more usable format, such as:
   extraction of fields with noise in the text—this can be used to address a situation where the background of a document, wear and tear or tampering create noise in the OCR image of the text. The processing workflow described is able to understand the expected noise on a per-document basis, allowing possible corrections to be applied on a finer scale per document;
   naming/date conventions: as there is no internationally agreed upon format for name (first name, middle name and last name), dates, address etc., each document may follow its own conventions. This is especially true with documents originating from different countries using different languages (which may have text right to left, left to right, dates in typed out format in a local language etc.). Each of these multitude of different formats can be addressed per document/per field basis and the extraction result can be returned in a standard format;
   document attributes such as address, passport number, date of birth, etc. can be converted into standard formats and verified against a trusted source (e.g., government databases) to ensure accuracy of the extraction process as well as to prevent fraud/forgery, when such an option is available;
   the extracted elements can be provided as inputs to existing standard fraud models such as transaction fraud systems, credit checks etc. as additional data to improve the accuracy of those models and systems. Examples of fraud detection mechanisms are discussed in greater detail below.

### Fraud Detection Stage

Detecting possible forgery in documents is a crucial step in verifying a document's authenticity. Since the document alignment stage returns a properly aligned and cropped version of the document, a number of fraud scenarios can be detected with relative ease compared to conventional approaches. These fraud scenarios may include one or more of the following:
Face injection: if a face in a document has been tampered with, it can be detected by checking for editing artefacts, expected background on the document (because certain documents have strict background/face size restrictions which a forger might not be aware of), expected age/gender range etc.;
Font injection: each document's fonts can be identified on a properly aligned document with relatively high precision. This helps determine if the text in a document has been tampered with, as edited document text may not fit the font, spacing, lettering formats, and background and size constraints of a valid document;
Holograms and logos: objects such as holograms, watermarks, logos etc. can be detected and verified against official versions of the same. Certain ID cards and passports have holograms of the faces as a redundancy factor—these can be checked for similarity against the face photo in a document;
Color profiles: if the document has been edited or filtering has been applied to the document, it can sometimes be screened out by matching against the expected color profile of an official, known to be valid version of the document;
Screenshots or screen captures: external recordings of a screen and screenshots can be detected based on screen flicker artefacts, other objects in an image, UI elements etc. on the screen;
Fraud document fingerprints: the internet provides access to many sample and fake documents. Each of those can be scraped and a database of such documents can be digitally fingerprinted. This helps detect situations where an internet sample, fake document or an edited version of the same is submitted for verification;
Digital document fingerprints: in the case of digital documents, checksums and hashes can be used to verify the digital fingerprint of the document in addition to other forms of fraud checks;
Database checks: an increasingly large number of official entities (government agencies, etc.) provide databases that can be user to authenticate official documents issued by those entities. These databases provide an additional level of security that prevents acceptance or verification of fraudulent documents that are able to pass other fraud checks.

Each of the fraud scenarios can be associated with a score, with the scores combined to generate an overall score or evaluation for a subject document. In some embodiments, certain fraud attempts such as face injection, font injection or a fake document may cause a rejection of the document in question. Other forms of potential fraud, such as a database match failure (due to a certain database not containing details of everyone) may be flagged but not used as a cause for rejection. The potential fraud indications and associated confidence levels can be used to allow or reject a document with reference to a specific application or use case.

In some embodiments, the different fraud checks can be selected or applied independently, depending on the use case. For example, a low risk of fraud use case may skip an official database check, while a banking application may require a strict criterion applied to all of the fraud checks. The fraud scenarios can be configured on a per-document/per-field basis based on a document's template. This approach lends itself to more effectively dealing with the wide variety of documents that are available.

In addition to the advantages mentioned, embodiments of the systems and methods described herein for document authentication and verification may provide one or more of the following advantages and benefits:
Scalability: the system and methods may be used with 100s to 1000s of templates at a time (it is noted that the described processes have been tested with several hundred templates);
Data requirement: the system and methods require only a single image of a known valid document to create a template;
Template creation speed: most, if not all, of the template creation process can be automated (including identifying salient features and the types of features present);
Diversity: the system and methods include the ability to combine features from different modes (such as image and text) into a score irrespective of the detection mechanisms used. Different detection mechanisms can have different accuracies and may be used to identify and extract different features in a document. Each attribute may be given a weight which helps calculate a score by aggregating the weights and probabilities of detection. This produces a score or scores that represent all of the different detection mechanisms;
Number of compared fields: the system and methods typically use between 20 and 100 attributes per template. Each attribute is a point of verification, providing a nuanced verification mechanism;
Debugging: the system and methods provide the ability to identify which attribute(s) were not able to be verified, as each field is dealt with separately. If a “must be verified” field (a logo or face for example) is not present, that can be identified quickly, as each field is detected separately;
   This is in contrast to a conventional single classifier approach where it is more difficult to spot individual field errors because the verification score is based on a single model. Separate attribute detection also allows for different “must verify” fields for different clients based on their specific requirements, which is not possible in a single classifier-based verification scenario;
Extraction: can extract information from the document and format the information into multiple forms, as the template is understood at a field level;
Robustness: the aggregate of several scores produces a metric that is more robust to noise compared to a single document level classifier. For example, a single classifier approach is prone to adversarial attacks (where a specific gradient noise added to an image could make the classifier classify a dog as a cat, for example). Since the system and methods described herein use multiple attributes across modes, these kinds of attacks are not possible as a gradient noise that affects one attribute won't affect others (as attributes are associated with different training mechanisms using different modes of data); and
Coverage: compared to traditional methods, the system and methods described have the ability to combine multiple detection and recognition mechanisms and are able to extract and score information using them—this increases the types of documents that can be evaluated. For example, the described system is capable of processing and verifying or authenticating documents that include:
   identification documents;
   certificates of completing a course of study;
   professional certifications;
   diplomas;
   registrations for events;
   receipts for payment of fees;
   vouchers for a product or service;
   documents for entry to a venue;
   mail-in ballots (where the logos, headers, seals/holograms, field details, document layout and signatures can be used to authenticate the document as valid as well as to extract a person's vote); and
   store receipts (where the system can be used to compile billing information).
      Given such flexibility, the system is capable of being applied to a wide variety of use cases, including identity cards, driver's licenses, passports, educational certificates, bank statements, proof of address statements, birth certificates, billing statements, insurance cards, voting ballots (mail-in ballots), digital identity and electronic national identity documents, and documents being used to show a proof of registration or certification.

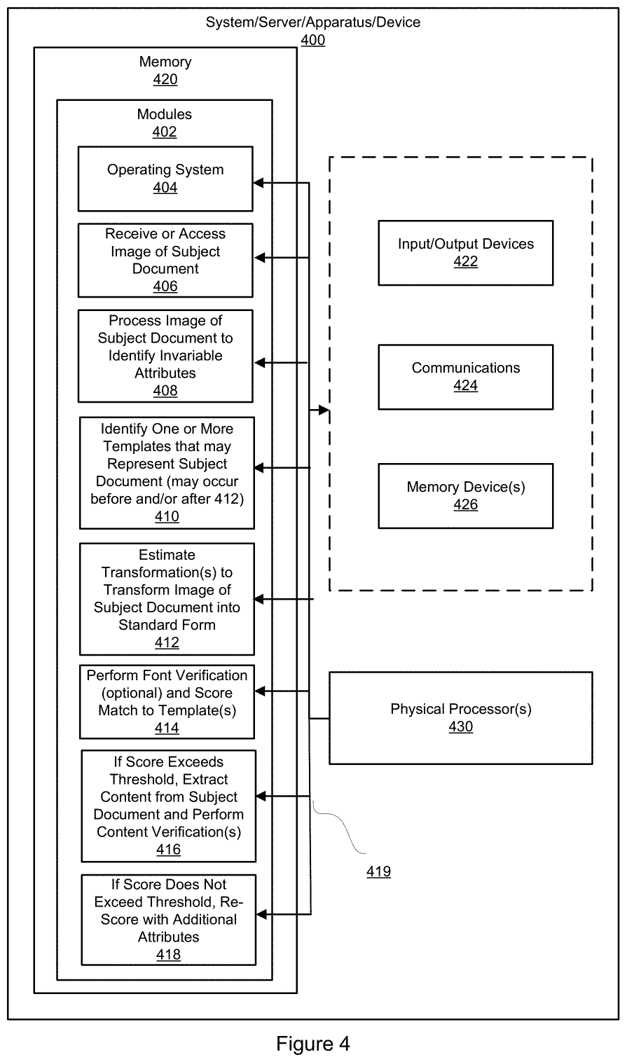

FIG. 4 is a diagram illustrating elements or components that may be present in a computing device, server, platform, or system 400 configured to implement a method, process, function, or operation in accordance with some embodiments of the invention. As noted, in some embodiments, the inventive system and methods may be implemented in the form of an apparatus that includes a processing element and set of executable instructions. In some embodiments, the apparatus may be a server that is part of a remotely located platform or system. The executable instructions may be part of a software application and arranged into a software architecture. In general, an embodiment of the invention may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Each application module or sub-module may correspond to a specific function, method, process, or operation that is implemented by the module or sub-module. Such function, method, process, or operation may include those used to implement one or more aspects of the disclosed system and methods, such as for.
1. Receiving or accessing an image of a subject document;
2. Processing the image to identify and/or extract one or more invariable attributes of the subject document;
3. Identifying one or more templates representing a document of the type of the subject document based on a match or similarity to the identified invariable attributes in the subject document and those associated with each of the templates;
   Note that this step may occur prior to and/or subsequent to the step of determining a suitable transformation to apply to the image of the subject document to transform it into a form in which it may be better compared to an image of a standard form of a document associated with each template;
4. Estimating a transformation (if needed) to transform the image of the subject document into a standard form of an image of the type represented by the most likely or best fitting templates;
   Evaluating each potential transformation or set of transformations to determine the one or ones that produce the best fit to the image associated with a template or templates;
5. Applying the estimated transformation(s) to the image of the subject document;
6. Generating a score reflecting a confidence level or believed accuracy in a match between the subject document and one or more templates based on the transformation(s);
   Performing font verification processing to either further verify the accuracy of the correspondence between the subject document and one or more templates, and/or to assist in determining the most likely document template which represents the subject document;
7. Determining if the generated score satisfies a threshold value or confidence level;
   If the generated score satisfies the threshold value or confidence level, then classifying the subject document as a specific document type or class based on the template which best represents the subject document;
   Accessing a file and/or meta-data associated with the template representing the class or type of the subject document;
   Given the class of the subject document, identifying/extracting one or more fields, data, elements, attributes, or aspects from the subject document for use in further authentication or verification processing (to compare with the attributes and requirements of the template for both invariable attributes and content);
      Performing fraud detection processing;
      Content format checks (e.g., for dates, identification numbers, etc.);
      Performing font verification processing on extracted content data or information (such as a date of birth) to determine if the information in a field is in a valid typeface, has expected spacing, etc.;
      Accessing external databases to confirm or validate extracted content data or information, such as a date of birth, name, address, license identification number, etc.
   If the generated score does not satisfy the threshold level or confidence value, then re-scoring with additional attributes specific to the most likely template (if any available) and re-doing the processing from the transformation estimation step forwards, and rejecting the document as being unable to be verified or authenticated if the score still doesn't satisfy the threshold.

As shown in the figure, system 400 may represent a server or other form of computing or data processing device or apparatus. Modules 402 each contain a set of executable instructions, where when the set of instructions is executed by a suitable electronic processor (such as that indicated in the figure by “Physical Processor(s) 430”), system (or server, apparatus, or device) 400 operates to perform a specific process, operation, function or method. Modules 402 are stored in a memory 420, which typically includes an Operating System module 404 that contains instructions used (among other functions) to access and control the execution of the instructions contained in other modules. The modules 402 in memory 420 are accessed for purposes of transferring data and executing instructions by use of a “bus” or communications line 419, which also serves to permit processor(s) 430 to communicate with the modules for purposes of accessing and executing a set of instructions. Bus or communications line 419 also permits processor(s) 430 to interact with other elements of system 400, such as input or output devices 422, communications elements 424 for exchanging data and information with devices external to system 400, and additional memory devices 426.

As shown in the figure, modules 402 may contain one or more sets of instructions for performing a method or function described with reference to FIGS. 1(b), 1(f), 2(a), or 2(b). These modules may include those illustrated but may also include a greater number or fewer number than those illustrated. Further, the computer-executable instructions that are contained in the modules may be executed by the same or by different processors.

As an example, Receive or Access Image of Subject Module 406 may contain instructions that when executed perform a process to obtain, receive as an input, retrieve or otherwise access an image of a subject document. The image may be provided by a user via an upload to a website or as an attachment to a message. Process Image of Subject Document to Identify Invariable Attributes Module 408 may contain instructions that when executed perform a process to identify one or more invariable attributes in the image of the subject document. As has been described, these may comprise labels, headers, field names, logos, holograms, seals, or similar features that can be recognized with confidence even if an image is skewed or distorted, and do not represent information or data provided by a person in possession of the document. Identify One or More Templates that Represent Subject Document Module 410 may contain instructions that when executed perform a process to determine one or more templates that are most likely to represent ort correspond to the subject document based on the invariable attributes. Estimate Transformation(s) to Transform Image of Subject Document into Standard Form Module 412 may contain instructions that when executed perform a process to determine one or more transformations of the types described herein (homography, affine, rotation, etc.) to transform the image of the subject document into a standard form of the document type represented by each of one or more templates. This can assist with more accurate processing of other elements of the image. Perform Font Verification (optional) and Score Match to Template(s) Module 414 may contain instructions that when executed perform a process to verify the font used in the subject document for one or more of the invariable attributes as part of further verifying the most likely template that represents or corresponds to the subject document. The module may also contain instructions that generate a score representing the relative degree of matching of the subject document to each of one or more templates. If Score Exceeds Threshold, Extract Content from Subject Document and Perform Content Verification(s) Module 416 may contain instructions that when executed perform a process to determine if the subject document score exceeds a desired threshold and if so, extract content information or datafrom the subject document. The extracted content may be subjected to one or more further tests or evaluations as part of authenticating or verifying the subject document and the information it contains. In some embodiments, these further tests or evaluations may comprise performing fraud detection processing, content format checks, performing font verification processing on extracted content data or information, or accessing external databases to confirm or validate extracted content data or information. If Score Does Not Exceed Threshold, Re-Score with Additional Attributes Module 418 may contain instructions that when executed perform a process to generate a revised score for the subject document after taking into account additional attributes from one or more templates.

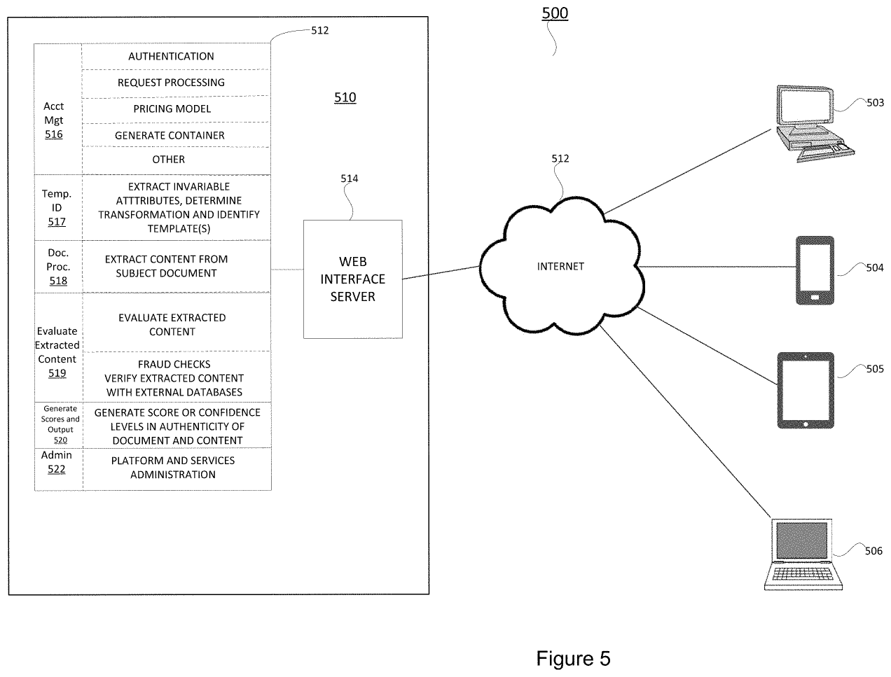

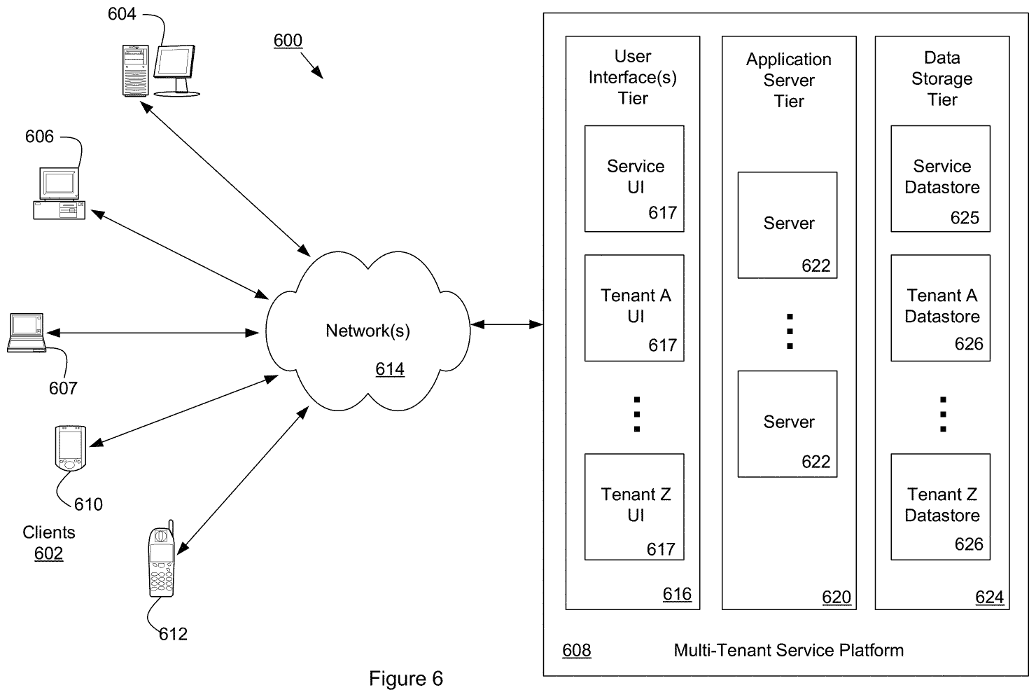

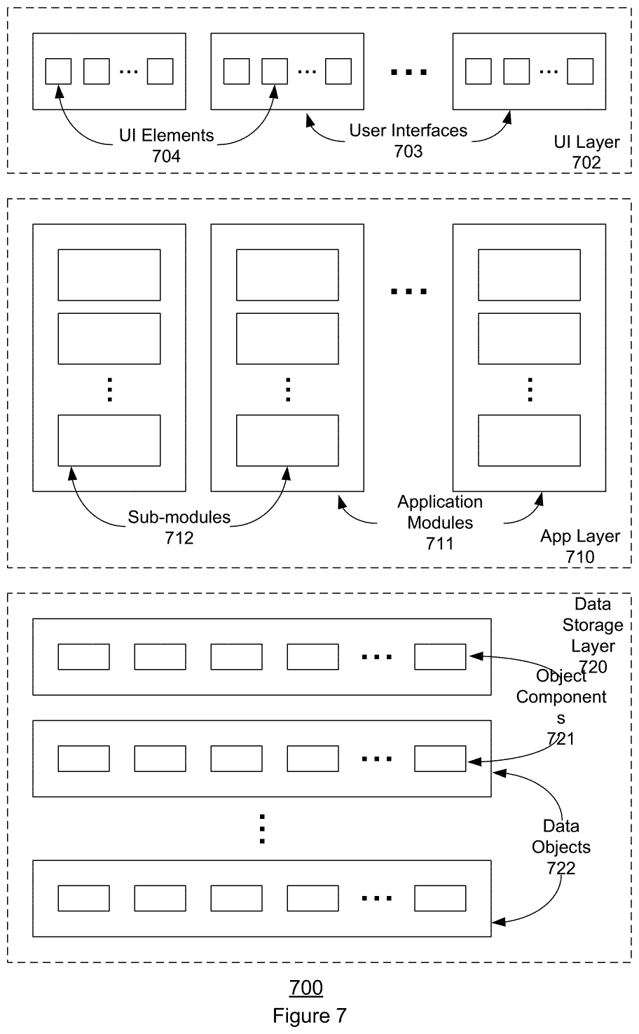

In some embodiments, the functionality and services provided by the system and methods described herein may be made available to multiple users by accessing an account maintained by a server or service platform. Such a server or service platform may be termed a form of Software-as-a-Service (SaaS). FIG. 5 is a diagram illustrating a SaaS system in which an embodiment of the invention may be implemented. FIG. 6 is a diagram illustrating elements or components of an example operating environment in which an embodiment of the invention may be implemented. FIG. 7 is a diagram illustrating additional details of the elements or components of the multi-tenant distributed computing service platform of FIG. 6, in which an embodiment of the invention may be implemented.

In some embodiments, the document processing system or service described herein may be implemented as micro-services, processes, workflows or functions performed in response to the submission of a subject document. The micro-services, processes, workflows or functions may be performed by a server, data processing element, platform, or system. In some embodiments, the document evaluation, authentication, or verification services and/or an identity verification service may be provided by a service platform located “in the cloud”. In such embodiments, the platform is accessible through APIs and SDKs. The font verification and image processing services may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 5-7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide document authentication and verifications services, coupled with confirming the validity of information contained in a document or the identity of a person presenting an identification document. Although in some embodiments, a platform or system of the type illustrated in FIGS. 5-7 may be operated by a 3 party provider to provide a specific set of business-related applications, in other embodiments, the platform may be operated by a provider and a different business may provide the applications or services for users through the platform.

FIG. 5 is a diagram illustrating a system 500 in which an embodiment of the invention may be implemented or through which an embodiment of the document authentication/verification services described herein may be accessed. In accordance with the advantages of an application service provider (ASP) hosted business service system (such as a multi-tenant data processing platform), users of the services described herein may comprise individuals, businesses, stores, organizations, etc. User may access the document processing services using any suitable client, including but not limited to desktop computers, laptop computers, tablet computers, scanners, smartphones, etc. In general, any client device having access to the Internet and (preferably a camera or other image capture device) may be used to provide an image of a document to the platform for processing. Users interface with the service platform across the Internet 512 or another suitable communications network or combination of networks. Examples of suitable client devices include desktop computers 503, smartphones 504, tablet computers 505, or laptop computers 506.

Document authentication and verification system 510, which may be hosted by a third party, may include a set of document authentication services 512 and a web interface server 514, coupled as shown in FIG. 5. It is to be appreciated that either or both of the document processing services 512 and the web interface server 514 may be implemented on one or more different hardware systems and components, even though represented as singular units in FIG. 5. Document processing services 512 may include one or more functions or operations for the processing of document images as part of authenticating or verifying a subject document.

In some embodiments, the set of applications available to a user may include one or more that perform the functions and methods described herein for document authentication, document verification, and verification of information contained in a document. As discussed, these functions or processing workflows may be used to verify a person's identification for purposes of allowing them to access a venue, use a system, obtain a set of services, etc. These functions or processing workflow may also or instead be used to verify a document and collect information contained in a document, such as for purposes of compliance with a requirement, proof of having completed a course of study or obtained a certification, determining how a person voted in an election, tracking of expenses, etc.

As examples, in some embodiments, the set of document processing applications, functions, operations or services made available through the platform or system 510 may include:
account management services 516, such as
   a process or service to authenticate a user wishing to submit a subject document for evaluation;
   a process or service to receive a request for evaluation of a subject document and prepare to evaluate an image of the subject document;
   a process or service to generate a price for the requested evaluation of a subject document (which could be based on the type or use for the document, the user requesting the evaluation, the industry involved and its requirements, prior experience in evaluating similar documents, the pricing arrangement with the user, etc.);
   a process or service to generate a container or instantiation of the document evaluation processes for the subject document; or
   other forms of account management services.
template identification processes or services 517, such as
   a process or service to identify and extract one or more invariable attributes from the image of the subject document;
   a process or service to determine a transformation or transformations to transform the image of the subject document into a more standard form of the type or class of document represented by one or more templates;
   a process or service to, based on a scoring method, identify one or more most likely templates that best represent the type of document in the image of the subject document;
document processing processes or service 518, such as
   a process or service that extracts content data or information from the subject document (such as information placed into fields, etc.);
evaluate extracted content processes or services 519, such as
   processes or services that identify potential fraud with regards to the content of the subject document, attempt to verify some or all of the extracted content with an external database, or otherwise process the extracted content to attempt to verify its authenticity (such as the font processing described herein);
generate scores and output processes or services 520, such as
   a processor service to generate or determine a score or metric representing a confidence level in the authenticity of a document and/or one or more of its attributes or content data, such as a heat map, numerical score, relative score, etc.; and
administrative services 520, such as
   a process or services to enable the provider of the document evaluation services and/or the platform to administer and configure the processes and services provided to requesters, such as by altering pricing models, altering workflows for processing a subject document, introducing different scoring methodologies, etc.

The platform or system shown in FIG. 5 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 6 is a diagram illustrating elements or components of an example operating environment 600 in which an embodiment of the invention may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., software) implemented at least in part by one or more of the computing devices. Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components, such as one or more electronic processors, microprocessors, central processing units (CPU), or controllers. Examples of suitable networks 614 include networks utilizing wired and/or wireless communication technologies and networks operating in accordance with any suitable networking and/or communication protocol (e.g., the Internet).

The distributed computing service/platform (which may also be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service U” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 622 shown in the figure may be implemented with a set of computers and/or components including computer servers and processors, and may perform various functions, methods, processes, or operations as determined by the execution of a software application or set of instructions. The data storage tier 624 may include one or more data stores, which may include a Service Data store 625 and one or more Tenant Data stores 626. Data stores may be implemented with any suitable data storage technology, including structured query language (SQL) based relational database management systems (RDBMS).

Service Platform 608 may be multi-tenant and may be operated by an entity in order to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 622 that are part of the platform's Application Server Tier 620. As noted with regards to FIG. 5, the platform system shown in FIG. 6 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the document authentication/verification processing described herein) are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 7 is a diagram illustrating additional details of the elements or components of the multi-tenant distributed computing service platform of FIG. 6, in which an embodiment of the invention may be implemented. The software architecture shown in FIG. 7 represents an example of an architecture which may be used to implement an embodiment of the invention. In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, in which an embodiment of the invention may be implemented. The example architecture includes a user interface layer or tier 702 having one or more user interfaces 703. Examples of such user interfaces include graphical user interfaces and application programming interfaces (APIs). Each user interface may include one or more interface elements 704. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote and may include interface elements such as parameterized procedure calls, programmatic objects and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing business related data processing and services to a user of the platform). Such function, method, process, or operation may include those used to implement one or more aspects of the inventive system and methods, such as for one or more of the processes or functions described with reference to FIGS. 1(b), 1(c), 1(g), 2(a), 2(b), 4 and 5:
1. Receiving or accessing an image of a subject document;
2. Processing the image to identify and/or extract one or more invariable attributes of the subject document;
3. Identifying one or more templates representing a document of the type of the subject document based on a match or similarity to the identified invariable attributes in the subject document and those associated with each of the templates;
   Note that this step may occur prior to and/or subsequent to the step of determining a suitable transformation to apply to the image of the subject document to transform it into a form in which it may be better compared to an image of a standard form of a document associated with each template;
4. Estimating a transformation (if needed) to transform the image of the subject document into a standard form of an image of the type represented by the most likely or best fitting templates;
   Evaluating each potential transformation or set of transformations to determine the one or ones that produce the best fit to the image associated with a template or templates;
5. Applying the estimated transformation(s) to the image of the subject document;
6. Generating a score reflecting a confidence level or believed accuracy in a match between the subject document and one or more templates based on the transformation(s);
   Performing font verification processing to either further verify the accuracy of the correspondence between the subject document and one or more templates, and/or to assist in determining the most likely document template which represents the subject document;
7. Determining if the generated score satisfies a threshold value or confidence level;
   If the generated score satisfies the threshold value or confidence level, then classifying the subject document as a specific document type or class based on the template which best represents the subject document;
   Accessing a file and/or meta-data associated with the template representing the class or type of the subject document;
   Given the class of the subject document, identifying/extracting one or more fields, data, elements, attributes, or aspects from the subject document for use in further authentication or verification processing (to compare with the attributes and requirements of the template for both invariable attributes and content);
      Performing fraud detection processing;
      Content format checks (e.g., for dates, identification numbers, etc.);
      Performing font verification processing on extracted content data or information (such as a date of birth) to determine if the information in a field is in a valid typeface, has expected spacing, etc.;
      Accessing external databases to confirm or validate extracted content data or information, such as a date of birth, name, address, license identification number, etc.
   If the generated score does not satisfy the threshold level or confidence value, then re-scoring with additional attributes specific to the most likely template (if any available) and re-doing the processing from the transformation estimation step forwards, and rejecting the document as being unable to be verified or authenticated if the score still doesn't satisfy the threshold.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 5-7 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review. As another example, the image and text processing described herein could be used with robotic-process-automation efforts, which rely on an understanding of a current computer screen and operate to infer a user's activities.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

In some embodiments, certain of the methods, models or functions described herein may be embodied in the form of a trained neural network, where the network is implemented by the execution of a set of computer-executable instructions. The instructions may be stored in (or on) a non-transitory computer-readable medium and executed by a programmed processor or processing element. The specific form of the method, model or function may be used to define one or more of the operations, functions, processes, or methods used in the development or operation of a neural network, the application of a machine learning technique or techniques, or the development or implementation of an appropriate decision process. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

A machine learning model is a set of layers of connected neurons that operate to make a decision (such as a classification) regarding a sample of input data. A model is typically trained by inputting multiple examples of input data and an associated correct “response” or decision regarding each set of input data. Thus, each input data example is associated with a label or other indicator of the correct response that a properly trained model should generate. The examples and labels are input to the model for purposes of training the model. When trained (i.e., the weights connecting neurons have converged and become stable or within an acceptable amount of variation), the model will operate to respond to an input sample of data to generate a correct response or decision.

Convolutional Neural networks or CNNs use the fact that most of the processing is replicated in different parts of the image (for example, in the context of the present disclosure, one might want to detect a document no matter where it is present in an image). A CNN uses multiple levels of filters (stacked at each level) in order to simplify the contents of an image to effectively determine a class or a hash. Each filter applies the same operation (for example, edge detection) throughout the image instead of having an array of neurons relative to the size of the input image (for dot products) that is required in a fully connected neural network. This makes the use of a CNN an efficient approach, as the size of the filters are much smaller than the input image (e.g., the filters are typically 3×3 or 5×5 arrays, while images are typically of 1000×1000 in size). The outputs of the filters from a layer are input to the next layer which operates on a slightly higher level of information (for example, the first layer may operate on raw image pixels, the second layer may have edge maps as inputs, a few layers from the start may work on basic shapes like circles, arcs or lines, and further layers may have higher level contexts such as wheels, eyes, tail etc.). This way of increasing the complexity at each level helps share filters across classes (for example, an animal classifier might share the same set of lower level filters to detect different types of animal eyes).

Convolutional networks are widely used in models that perform detection and individual attribute recognition steps. However, note that the document authentication and verification framework/system described herein is not limited to being implemented using CNNs. Other model(s) that reliably perform the detection and identification tasks can be used along with the framework/system for reliable verification and extraction (such as SVMs, cascade-based detectors like Haar, LBP, HOG etc.). The detection models help localize the region of interest (for example, to crop a document from an image of a document in a desk or to detect a face from an ID). Recognition/search models help classify/verify the type of attributes (for example, a face recognition model that compares the face in an ID to a given user's face).

Convolutional Neural Networks (CNNs) and other Machine Learning models can be used in several parts of the document authentication and verification processes described herein, including but not limited to:
OCR models that detect and recognize text;
Attribute detectors that detect attributes such as logos, signatures, faces, holograms, flags, seals etc.;
Artefact detectors that detect image artefacts such as blur, glare, noise etc. to provide feedback about a degraded or altered document;
Segmentation models and auto-encoders that clean up noise in a document being verified;
Font segmentation models that segment characters during a font-verification stage of the processing;
Matchers that match the extracted fonts to known standard fonts to verify their authenticity;
Document detectors that help detect and crop the subject document of interest from an image that contains the document along with a background; and
Fraud detection models, which may include:
   Face injection detectors that recognize edited faces in the document;
   Font injection detectors that detect injected fonts in the document;
   Screenshot or screen capture classifiers that classify whether or not a document is captured from a digital screen or a printout;
   Hologram verification models that authenticate holograms detected in a document being verified;
   Color profile matchers that matches a document's color profile with an expected profile; and
   Models that extract document fingerprints from known fraudulent documents to be cross-checked against an incoming document during verification processing.

Embodiments of the system, methods and devices described herein include the following:
1. A system for authenticating a document, comprising:
an electronic processor programmed with a set of executable instructions, where when executed, the instructions cause the system to:
receive an image of a subject document;
identify one or more invariable attributes of the subject document, wherein an invariable attribute is one or more of a label, a title, a header, a field name, a logo, a hologram, a watermark, or a seal;
access a set of document templates, wherein each template represents an example of a type of document and includes information regarding a set of invariable attributes associated with each type of document;
identify a template in the set of document templates representing a document of the type of the subject document by comparing the identified invariable attributes of the subject document with the invariable attributes associated with each type of document of the set of templates;
access data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verify that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identify one or more elements of data placed in a field of the subject document for additional processing, wherein the additional processing includes comparing the identified data to the accessed data associated with the identified template, and further, wherein the additional processing comprises one or more of:
   fraud detection processing to identify possible instances of alteration or tampering with a document;
   format checking to determine if invariable attributes and the identified data are in an expected format for the type of document represented by the identified template;
   font verification processing to determine if the identified data is in the expected font type and font characteristic for the type of document represented by the identified template; and
   if applicable, accessing an external database to confirm validity of one or more of the identified data; and
if the additional processing indicates that the subject document is valid, then generating an indication that the subject document and the information it contains are valid.
2. The system of embodiment 1, wherein the subject document is one of a license, a passport, an identification document, a certificate, a diploma, a receipt, or a document to permit entry to a venue.
3. The system of embodiment 1, wherein the information regarding the set of invariable attributes associated with each template is in the form of one or more of data stored in a file and metadata.
4. The system of embodiment 1, wherein identifying a template in the set of templates representing a document of the type of the subject document further comprises determining if a score associated with the subject document exceeds a threshold value, wherein the score is based on the invariable attributes of the subject document.
5. The system of embodiment 1, wherein prior to verifying that the identified template is a sufficiently close match to the subject document, the instructions cause the system to operate to:
determine a transformation to transform the image of the subject document into a standard form of an image of a document of the type represented by the identified template; and
apply the determined transformation to the image of the subject document.
6. The system of embodiment 5, wherein the transformation to transform the image of the subject document into a standard form is one or more of a homography transformation, an affine transformation, and a rotation.
7. The system of embodiment 5, further comprising determining the transformation by evaluating how closely the result of applying the transformation to the image of the subject document matches the standard form of the image of the type of document represented by the identified template.
8. The system of embodiment 7, wherein evaluating how closely the result of applying the transformation to the image of the subject document matches the standard form of the image of the type of document represented by the identified template comprises using an outlier resistant estimating process.
9. The system of embodiment 1, wherein in response to generating an indication that the subject document and the information it contains are valid, the system operates to allow a person in possession of the subject document to enter a location, venue, or restricted area.
10. The system of embodiment 1, wherein the one or more elements of data placed in a field of the subject document identified for additional processing comprise information specific to a person that the subject document is purported to identify.
11. The system of embodiment 10, wherein the information specific to a person that the subject document is purported to identify comprises one or more of a name, a birth date, an address, and an identification number for the person or subject document.
12. A method of authenticating a document, comprising:
receiving an image of a subject document;
identifying one or more invariable attributes of the subject document, wherein an invariable attribute is one or more of a label, a title, a header, a field name, a logo, a hologram, a watermark, or a seal;
accessing a set of document templates, wherein each template represents an example of a type of document and includes information regarding a set of invariable attributes associated with each type of document;
identifying a template in the set of document templates representing a document of the type of the subject document by comparing the identified invariable attributes of the subject document with the invariable attributes associated with each type of document of the set of templates;
accessing data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verifying that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identifying one or more elements of data placed in a field of the subject document for additional processing, wherein the additional processing includes comparing the identified data to the accessed data associated with the identified template, and further, wherein the additional processing comprises one or more of:
   fraud detection processing to identify possible instances of alteration or tampering with a document;
   format checking to determine if invariable attributes and the identified data are in an expected format for the type of document represented by the identified template;
   font verification processing to determine if the identified data is in the expected font type and font characteristic for the type of document represented by the identified template; and
   if applicable, accessing an external database to confirm validity of one or more of the identified data; and
if the additional processing indicates that the subject document is valid, then generating an indication that the subject document and the information it contains are valid.
13. The method of embodiment 12, wherein the subject document is one of a license, a passport, an identification document, a certificate, a diploma, a receipt, or a document to permit entry to a venue.
14. The method of embodiment 12, wherein prior to verifying that the identified template is a sufficiently close match to the subject document, the method further comprises:
determining a transformation to transform the image of the subject document into a standard form of an image of a document of the type represented by the identified template; and
applying the determined transformation to the image of the subject document.
15. The method of embodiment 12, wherein the transformation to transform the image of the subject document into a standard form is one or more of a homography transformation, an affine transformation, and a rotation.
16. The method of embodiment 12, further comprising determining the transformation by evaluating how closely the result of applying the transformation to the image of the subject document matches the standard form of the image of the type of document represented by the identified template, and further wherein the evaluation comprises using an outlier resistant estimating process.
17. The method of embodiment 12, wherein in response to generating an indication that the subject document and the information it contains are valid, the method further comprises allowing a person in possession of the subject document to enter a location, venue, or restricted area.
18. The method of embodiment 12, wherein the one or more elements of data placed in a field of the subject document identified for additional processing comprise information specific to a person that the subject document is purported to identify.
19. The method of embodiment 18, wherein the information specific to a person that the subject document is purported to identify comprises one or more of a name, a birth date, an address, and an identification number for the person or subject document.
20. One or more non-transitory computer-readable media containing a set of executable instructions, wherein when executed by a programmed processor, the instructions cause a device to:
receive an image of a subject document;
identify one or more invariable attributes of the subject document, wherein an invariable attribute is one or more of a label, a title, a header, a field name, a logo, a hologram, a watermark, or a seal;
access a set of document templates, wherein each template represents an example of a type of document and includes information regarding a set of invariable attributes associated with each type of document;
identify a template in the set of document templates representing a document of the type of the subject document by comparing the identified invariable attributes of the subject document with the invariable attributes associated with each type of document of the set of templates;
access data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verify that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identify one or more elements of data placed in a field of the subject document for additional processing, wherein the additional processing includes comparing the identified data to the accessed data associated with the identified template, and further, wherein the additional processing comprises one or more of:
   fraud detection processing to identify possible instances of alteration or tampering with a document;
   format checking to determine if invariable attributes and the identified data are in an expected format for the type of document represented by the identified template;
   font verification processing to determine if the identified data is in the expected font type and font characteristic for the type of document represented by the identified template; and
   if applicable, accessing an external database to confirm validity of one or more of the identified data; and
if the additional processing indicates that the subject document is valid, then generating an indication that the subject document and the information it contains are valid.

Any of the software components, processes or functions described in this application may be implemented as software code to be executed by a processor using any suitable computer language such as Python, Java, JavaScript, C++ or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A system for authenticating a document, comprising:
an electronic processor programmed with a set of executable instructions, where when executed, the instructions cause the system to:
receive an image of a subject document;
identify one or more invariable attributes of the subject document, wherein an invariable attribute is one or more of a label, a title, a header, a field name, a logo, a hologram, a watermark, or a seal;
access a set of document templates, wherein each template represents an example of a type of document and includes information regarding a set of invariable attributes associated with each type of document;
identify a template in the set of document templates representing a document of the type of the subject document by comparing the identified invariable attributes of the subject document with the invariable attributes associated with each type of document of the set of templates;
access data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verify that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identify one or more elements of data placed in a field of the subject document for additional processing, wherein the additional processing includes comparing the identified data to the accessed data associated with the identified template, and further, wherein the additional processing comprises one or more of:
fraud detection processing to identify possible instances of alteration or tampering with a document;
format checking to determine if invariable attributes and the identified data are in an expected format for the type of document represented by the identified template;
font verification processing to determine if the identified data is in the expected font type and font characteristic for the type of document represented by the identified template; and
if applicable, accessing an external database to confirm validity of one or more of the identified data; and
if the additional processing indicates that the subject document is valid, then generating an indication that the subject document and the information it contains are valid.

2. The system of claim 1, wherein the subject document is one of a license, a passport, an identification document, a certificate, a diploma, a receipt, or a document to permit entry to a venue.

3. The system of claim 1, wherein the information regarding the set of invariable attributes associated with each template is in the form of one or more of data stored in a file and metadata.

4. The system of claim 1, wherein identifying a template in the set of templates representing a document of the type of the subject document further comprises determining if a score associated with the subject document exceeds a threshold value, wherein the score is based on the invariable attributes of the subject document.

5. The system of claim 1, wherein prior to verifying that the identified template is a sufficiently close match to the subject document, the instructions cause the system to operate to:
determine a transformation to transform the image of the subject document into a standard form of an image of a document of the type represented by the identified template; and
apply the determined transformation to the image of the subject document.

6. The system of claim 5, wherein the transformation to transform the image of the subject document into a standard form is one or more of a homography transformation, an affine transformation, and a rotation.

7. The system of claim 5, further comprising determining the transformation by evaluating how closely the result of applying the transformation to the image of the subject document matches the standard form of the image of the type of document represented by the identified template.

8. The system of claim 7, wherein evaluating how closely the result of applying the transformation to the image of the subject document matches the standard form of the image of the type of document represented by the identified template comprises using an outlier resistant estimating process.

9. The system of claim 1, wherein in response to generating an indication that the subject document and the information it contains are valid, the system operates to allow a person in possession of the subject document to enter a location, venue, or restricted area.

10. The system of claim 1, wherein the one or more elements of data placed in a field of the subject document identified for additional processing comprise information specific to a person that the subject document is purported to identify.

11. The system of claim 10, wherein the information specific to a person that the subject document is purported to identify comprises one or more of a name, a birth date, an address, and an identification number for the person or subject document.

12. A method of authenticating a document, comprising:
receiving an image of a subject document;
identifying one or more invariable attributes of the subject document, wherein an invariable attribute is one or more of a label, a title, a header, a field name, a logo, a hologram, a watermark, or a seal;
accessing a set of document templates, wherein each template represents an example of a type of document and includes information regarding a set of invariable attributes associated with each type of document;
identifying a template in the set of document templates representing a document of the type of the subject document by comparing the identified invariable attributes of the subject document with the invariable attributes associated with each type of document of the set of templates;
accessing data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verifying that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identifying one or more elements of data placed in a field of the subject document for additional processing, wherein the additional processing includes comparing the identified data to the accessed data associated with the identified template, and further, wherein the additional processing comprises one or more of:
fraud detection processing to identify possible instances of alteration or tampering with a document;
format checking to determine if invariable attributes and the identified data are in an expected format for the type of document represented by the identified template;
font verification processing to determine if the identified data is in the expected font type and font characteristic for the type of document represented by the identified template; and
if applicable, accessing an external database to confirm validity of one or more of the identified data; and
if the additional processing indicates that the subject document is valid, then generating an indication that the subject document and the information it contains are valid.

13. The method of claim 12, wherein the subject document is one of a license, a passport, an identification document, a certificate, a diploma, a receipt, or a document to permit entry to a venue.

14. The method of claim 12, wherein prior to verifying that the identified template is a sufficiently close match to the subject document, the method further comprises:
determining a transformation to transform the image of the subject document into a standard form of an image of a document of the type represented by the identified template; and
applying the determined transformation to the image of the subject document.

15. The method of claim 12, wherein the transformation to transform the image of the subject document into a standard form is one or more of a homography transformation, an affine transformation, and a rotation.

16. The method of claim 12, further comprising determining the transformation by evaluating how closely the result of applying the transformation to the image of the subject document matches the standard form of the image of the type of document represented by the identified template, and further wherein the evaluation comprises using an outlier resistant estimating process.

17. The method of claim 12, wherein in response to generating an indication that the subject document and the information it contains are valid, the method further comprises allowing a person in possession of the subject document to enter a location, venue, or restricted area.

18. The method of claim 12, wherein the one or more elements of data placed in a field of the subject document identified for additional processing comprise information specific to a person that the subject document is purported to identify.

19. The method of claim 18, wherein the information specific to a person that the subject document is purported to identify comprises one or more of a name, a birth date, an address, and an identification number for the person or subject document.

20. One or more non-transitory computer-readable media containing a set of executable instructions, wherein when executed by a programmed processor, the instructions cause a device to:
receive an image of a subject document;
identify one or more invariable attributes of the subject document, wherein an invariable attribute is one or more of a label, a title, a header, a field name, a logo, a hologram, a watermark, or a seal;
access a set of document templates, wherein each template represents an example of a type of document and includes information regarding a set of invariable attributes associated with each type of document;
identify a template in the set of document templates representing a document of the type of the subject document by comparing the identified invariable attributes of the subject document with the invariable attributes associated with each type of document of the set of templates;
access data associated with the identified template, wherein the accessed data comprises one or more of data regarding a font type associated with an invariable attribute of the identified template, data regarding a font characteristic associated with an invariable attribute of the identified template, and a data format for information entered into a field associated with an invariable attribute of the identified template;
verify that the identified template is a sufficiently close match to the subject document by comparing a font or font characteristic of one or more of the invariable attributes of the subject document to the data regarding a font or font characteristic associated with an invariable attribute of the identified template;
if the identified template is a sufficiently close match to the subject document, then identify one or more elements of data placed in a field of the subject document for additional processing, wherein the additional processing includes comparing the identified data to the accessed data associated with the identified template, and further, wherein the additional processing comprises one or more of:
fraud detection processing to identify possible instances of alteration or tampering with a document;
format checking to determine if invariable attributes and the identified data are in an expected format for the type of document represented by the identified template;
font verification processing to determine if the identified data is in the expected font type and font characteristic for the type of document represented by the identified template; and
if applicable, accessing an external database to confirm validity of one or more of the identified data; and
if the additional processing indicates that the subject document is valid, then generating an indication that the subject document and the information it contains are valid.
